(19) United States
(12) Patent Application Publication
(10) Pub. No.: US 2017/0017336 A1
(43) Pub. Date: Jan. 19, 2017

(54) DETECTING DEVICE AND ELECTRONIC EQUIPMENT PROVIDED WITH SAME, AND METHOD OF CONTROLLING DETECTING DEVICE

(71) Applicant: Sharp Kabushiki Kaisha, Sakai City, Osaka (JP)

(72) Inventor: Masashi Mayumi, Sakai City (JP)

(21) Appl. No.: 15/124,055

(22) PCT Filed: Feb. 18, 2015
(86) PCT No.: PCT/JP2015/054361

§ 371 Date: Sep. 7, 2016

(30) Foreign Application Priority Data
Apr. 30, 2014 (JP) 2014-093796

(51) Int. Cl. G06F 3/041; G06F 3/044

(52) U.S. Cl. CPC G06F 3/0416; G06F 3/044; G06F 3/0412; G06F 2203/04106

(57) ABSTRACT

A detecting device that can sufficiently exhibit its performance even when used integrally with a high-resolution display device is implemented. In a detecting device that can perform a location detection process using both of a self-capacitance scheme and a mutual-capacitance scheme, a touch panel controller drives a location detection electrode group formed in an area where location detection by the location detection process is to be performed, for example, such that the location detection process using the self-capacitance scheme is performed during a vertical flyback period (52) and the location detection process using the mutual-capacitance scheme is performed during horizontal flyback periods within an effective vertical scanning period (51). As such, when the location detection process is performed using at least one of the self-capacitance scheme and the mutual-capacitance scheme, the touch panel controller drives the location detection electrode group based on a synchronizing signal.

### TECHNICAL FIELD

The present invention relates to, for example, a detecting device having a touch panel, and more particularly to a detecting device that is used integrally with a display device and that is capable of performing location detection using both of a self-capacitance scheme and a mutual-capacitance scheme.

### BACKGROUND ART

As an input device for performing operations in a computer system, etc., attention is focused on a touch panel conventionally. In an electrostatic capacitance type touch panel, a location of an object to be detected, such as a user's (operator's) finger or a touch pen, is detected based on a change in electrostatic capacitance. Such an electrostatic capacitance type touch panel is generally used integrally with a display device such as a liquid crystal display device. Note that, in this specification, a device composed of a touch panel and a controller (touch panel controller) that controls the operation of the touch panel is referred to as “detecting device”.

As location detection schemes using an electrostatic capacitance type, a self-capacitance scheme and a mutual-capacitance scheme are known. The self-capacitance scheme is a scheme in which a location of an object to be detected is measured by detecting an increase in electrostatic capacitance caused by the contact or approach of the object to be detected to the touch panel. The mutual-capacitance scheme is a scheme in which a location of an object to be detected is measured based on the difference in electrostatic capacitance between adjacent sensors occurring due to the contact or approach of the object to be detected to the touch panel. There are some recent detecting devices which are capable of performing location detection using both of the self-capacitance scheme and the mutual-capacitance scheme.

Meanwhile, in recent years, there has been a remarkable enhancement to the performance of the detecting device. The functions provided to the detecting device with enhanced performance include, for example, a hover function, a pen input function, a high-speed response function, a low power consumption function, a water droplet malfunction prevention function, and a multi-touch function. As such, recent detecting devices are provided with many functions. In addition, display devices have achieved a remarkable increase in resolution and a remarkable slimming down.

The touch panel is conventionally known to be susceptible to noise from the display device. Since a high-sensitivity electrostatic-capacitance-type touch panel is particularly susceptible to noise, if driving of the touch panel and driving of the display device interfere with each other, then unintended malfunction occurs. In addition, when there is such interference, the accuracy of location detection also decreases. Hence, to prevent the occurrence of malfunction and improve the accuracy of location detection, performing location detection during a period during which driving of the display device is stopped (hereinafter, referred to as “pause period”) is proposed.

In addition, Japanese Patent Application Laid-Open No. 2013-168083 discloses an invention of a detecting device capable of freely switching between signals for controlling the timing (scan timing) of sensing by a sensing unit (touch panel). According to the invention, the sensing timing can be changed depending on the operating conditions of a display device, and thus, detection accuracy improves.

### PRIOR ART DOCUMENT

### Patent Document

[Patent Document 1] Japanese Patent Application Laid-Open No. 2013-168083

### SUMMARY OF THE INVENTION

### Problems to be Solved by the Invention

As described above, the conventional detecting device performs location detection during a pause period of the display device. However, in recent years, since display devices have achieved a remarkable increase in resolution as described above, a drive period of a touch panel (a period during which the touch panel can be driven without causing interference) is shortened. For example, as shown in FIG. 27, the length of a drive period in a given display device with low resolution is indicated by an arrow of reference character 91 and the length of a pause period (a period during which the touch panel can be driven) is indicated by an arrow of reference character 92; on the other hand, the length of a drive period in a given display device with high resolution is indicated by an arrow of reference character 93 and the length of a pause period is indicated by an arrow of reference character 94. As can be grasped from FIG. 27, the drive period of the touch panel becomes shorter as the resolution of the display device increases. By an enhancement to the performance of the detecting device such as that described above in addition to such an increase in the resolution of the display device, it has become difficult in recent years to avoid interference between driving of the touch panel and driving of the display device. If a sufficient drive period of the touch panel is reserved, then driving of the touch panel and driving of the display device interfere with each other, causing unintended malfunction and a reduction in detection accuracy as described above. On the other hand, if the drive period of the touch panel is shortened to avoid interference, then sufficient performance of the touch panel is not exhibited.

An object of the present invention is therefore to implement a detecting device capable of sufficiently exhibiting its performance even when used integrally with a high-resolution display device (a display device with a relatively short pause period).

### Means for Solving the Problems

A first aspect of the present invention is directed to a detecting device capable of performing a location detection process using both of a self-capacitance scheme and a mutual-capacitance scheme, the location detection process being a process of detecting a location contacted or approached by a detection object, the detecting device including,

a sensing unit having a location detection electrode group formed in an area where location detection by the location detection process is to be performed; and

a detection control unit configured to drive the location detection electrode group to perform the location detection process, wherein

the detection control unit drives the location detection electrode group based on a synchronizing signal when the location detection process is performed using at least one of the self-capacitance scheme and the mutual-capacitance scheme.

According to a second aspect of the present invention, in the first aspect of the present invention,

the location detection electrode group is formed in an area corresponding to an image display unit of an external display device, and

the detecting device is used integrally with the display device.

According to a third aspect of the present invention, in the second aspect of the present invention,
the detection control unit drives the location detection electrode group such that both the location detection process using the self-capacitance scheme and the location detection process using the mutual-capacitance scheme are performed during a pause period that is a period during which operation of the display device is stopped.

According to a fourth aspect of the present invention, in the third aspect of the present invention,

when one of the self-capacitance scheme and the mutual-capacitance scheme is defined as a first scheme and an other is defined as a second scheme,
the detection control unit:
   drives, during a horizontal flyback period of the display device, the location detection electrode group based on the synchronizing signal such that the location detection process using the first scheme is performed; and
   drives, during a vertical flyback period of the display device, the location detection electrode group based on the synchronizing signal such that the location detection process using the second scheme is performed.

According to a fifth aspect of the present invention, in the second aspect of the present invention,

the detection control unit drives the location detection electrode group such that one of the location detection process using the self-capacitance scheme and the location detection process using the mutual-capacitance scheme is performed during a pause period that is a period during which operation of the display device is stopped.

According to a sixth aspect of the present invention, in the fifth aspect of the present invention,

when one of the self-capacitance scheme and the mutual-capacitance scheme is defined as a first scheme and an other is defined as a second scheme,
the detection control unit:
   drives, during a horizontal flyback period of the display device, the location detection electrode group based on the synchronizing signal such that the location detection process using the first scheme is performed; and
   drives, during a period other than the horizontal flyback period of the display device, the location detection electrode group such that the location detection process using the second scheme is performed.

According to a seventh aspect of the present invention, in the fifth aspect of the present invention,

when one of the self-capacitance scheme and the mutual-capacitance scheme is defined as a first scheme and an other is defined as a second scheme,
the detection control unit:
   drives, during a vertical flyback period of the display device, the location detection electrode group based on the synchronizing signal such that the location detection process using the first scheme is performed; and
   drives, during a period other than the vertical flyback period of the display device, the location detection electrode group such that the location detection process using the second scheme is performed.

According to an eighth aspect of the present invention, in the second aspect of the present invention,

the detection control unit can switch between electrode group drive schemes during operation of the display device, the electrode group drive schemes being used to drive the location detection electrode group and being identified by a combination of whether to perform the location detection process using the self-capacitance scheme; whether to perform the location detection process using the mutual-capacitance scheme; whether to use a synchronizing signal and a period during which the location detection process is performed when the location detection process using the self-capacitance scheme is performed, and whether to use a synchronizing signal and a period during which the location detection process is performed when the location detection process using the mutual-capacitance scheme is performed.

According to a ninth aspect of the present invention, in the eighth aspect of the present invention,

the detection control unit switches between the electrode group drive schemes, depending on a function to be executed.

According to a tenth aspect of the present invention, in the ninth aspect of the present invention,

a first drive scheme for an initial state and a second drive scheme for at least one specific function are prepared in advance as the electrode group drive schemes, and

the detection control unit switches the electrode group drive scheme from the first drive scheme to the second drive scheme upon a start of execution of the specific function, and switches the electrode group drive scheme from the second drive scheme to the first drive scheme upon an end of the execution of the specific function.

According to an eleventh aspect of the present invention, in the eighth aspect of the present invention,

the detection control unit switches between synchronizing signals to be used, depending on the electrode group drive scheme.

A twelfth aspect of the present invention is directed to an electronic equipment including a display device having an image display unit; and a detecting device according to the first aspect of the present invention, the detecting device being integrally formed with the display device, wherein

the location detection electrode group is formed in an area corresponding to the image display unit, and

the synchronizing signal is provided to the detection control unit from the display device.

A thirteenth aspect of the present invention is directed to a method of controlling a detecting device capable of performing a location detection process using both of a self-capacitance scheme and a mutual-capacitance scheme, the location detection process being a process of detecting a location contacted or approached by a detection object, the method including,

a self-capacitance scheme detecting step of driving a location detection electrode group such that the location detection process is performed using the self-capacitance scheme, the location detection electrode group being formed in an area where location detection by the location detection process is to be performed; and

a mutual-capacitance scheme detecting step of driving the location detection electrode group such that the location detection process is performed using the mutual-capacitance scheme, wherein

in at least one of the self-capacitance scheme detecting step and the mutual-capacitance scheme detecting step, the location detection electrode group is driven based on a synchronizing signal.

According to a fourteenth aspect of the present invention, in the thirteenth aspect of the present invention,

the method further includes an electrode group drive scheme switching step of switching between electrode group drive schemes that are used to drive the location detection electrode group and that are identified by a combination of whether to perform the location detection process using the self-capacitance scheme; whether to perform the location detection process using the mutual-capacitance scheme; whether to use a synchronizing signal and a period during which the location detection process is performed when the location detection process using the self-capacitance scheme is performed, and whether to use a synchronizing signal and a period during which the location detection process is performed when the location detection process using the mutual-capacitance scheme is performed.

### Effects of the Invention

According to the first aspect of the present invention, when a location detection process using at least one of the self-capacitance scheme and the mutual-capacitance scheme is performed, the location detection electrode group is driven based on the synchronizing signal. By thus driving the location detection electrode group based on the synchronizing signal, a location detection process can be performed during a period during which the operation of a display device used integrally with the detecting device is stopped (pause period) (e.g., a horizontal flyback period or a vertical flyback period). Therefore, by performing a location detection process for implementing a function with a large influence of noise during a pause period of the display device, the occurrence of malfunction caused by noise from the display device is prevented. By the above, a detecting device is implemented that is capable of sufficiently exhibiting its performance even when used integrally with a high-resolution display device.

According to the second aspect of the present invention, the same effect as that obtained in the first aspect of the present invention can be obtained.

According to the third aspect of the present invention, both of a location detection process using the self-capacitance scheme and a location detection process using the mutual-capacitance scheme are performed during a pause period of the display device. Hence, when various functions are executed, the occurrence of malfunction caused by noise from the display device is prevented.

According to the fourth aspect of the present invention, a location detection process using one of the self-capacitance scheme and the mutual-capacitance scheme is performed during a horizontal flyback period, and a location detection process using the other scheme is performed during a vertical flyback period. That is, a location detection process using a relatively short pause period is performed, and a location detection process using a relatively long pause period is performed. Therefore, the results of location detection processes performed during two types of pause periods can be used separately depending on a function to be used by a user, etc. By this, a detecting device is implemented that is capable of more effectively executing various types of functions.

According to the fifth aspect of the present invention, a location detection process using one of the self-capacitance scheme and the mutual-capacitance scheme is performed during a pause period of the display device. Hence, as with the first aspect of the present invention, a detecting device is implemented that is capable of sufficiently exhibiting its performance even when used integrally with a high-resolution display device.

According to the sixth aspect of the present invention, a location detection process using one of the self-capacitance scheme and the mutual-capacitance scheme is performed during a horizontal flyback period, and a location detection process using the other scheme is performed during a period other than the horizontal flyback period. That is, a location detection process is performed during a pause period of the display device, and a location detection process is also performed during a drive period of the display device. Here, by performing a location detection process for implementing a function with a large influence of noise during a pause period of the display device, and performing a location detection process for implementing a function with a small influence of noise during a drive period of the display device, various types of functions provided to the detecting device can be implemented without causing malfunction. By the above, a detecting device is implemented that is capable of more sufficiently exhibiting its performance.

According to the seventh aspect of the present invention, the same effect as that obtained in the sixth aspect of the present invention can be obtained.

According to the eighth aspect of the present invention, an electrode group drive scheme (how to perform a location detection process) can be switched during the operation of the display device. Therefore, by switching between electrode group drive schemes as appropriate depending on the magnitude of the influence of noise exerted on a function to be executed, it is possible to use a pause period of the display device efficiently and to implement various types of functions without causing malfunction. By the above, a detecting device is implemented that is capable of more sufficiently exhibiting its performance.

According to the ninth aspect of the present invention, the same effect as that obtained in the eighth aspect of the present invention can be obtained.

According to the tenth aspect of the present invention, the occurrence of malfunction upon execution of the specific function can be more securely prevented.

According to the eleventh aspect of the present invention, the same effect as that obtained in the eighth aspect of the present invention can be obtained.

According to the twelfth aspect of the present invention, electronic equipment including a detecting device that provides the same effect as that provided in the first aspect of the present invention is implemented.

According to the thirteenth aspect of the present invention, the same effect as that provided in the first aspect of the present invention can be provided by the method of controlling a detecting device.

According to the fourteenth aspect of the present invention, the same effect as that provided in the eighth aspect of the present invention can be provided by the method of controlling a detecting device.

### BRIEF DESCRIPTION OF THE DRAWINGS

FIG. 1 is a signal waveform diagram for describing a method of driving a location detection electrode group in a detecting device according to a first embodiment of the present invention.

FIG. 2 is a block diagram showing an overall configuration of electronic equipment including the detecting device according to the first embodiment.

FIG. 3 is a block diagram showing a detailed configuration of the detecting device in the first embodiment.

FIG. 4 is a schematic diagram showing a configuration of the location detection electrode group in the first embodiment.

FIG. 5 is a diagram for describing a vertical scanning period.

FIG. 6 is a diagram for describing a horizontal scanning period.

FIG. 7 is a diagram for describing a pause period.

FIG. 8 is a waveform diagram showing a state of noise generated from a given liquid crystal display device.

FIG. 9 is a signal waveform diagram for describing a common method of driving the location detection electrode group for when a location detection process is performed.

FIG. 10 is a diagram for describing depiction of a signal waveform.

FIG. 11 is a signal waveform diagram for describing generation of drive signals for drive lines in the first embodiment.

FIG. 12 is a signal waveform diagram for describing a method of driving the location detection electrode group in a variant of the first embodiment.

FIG. 13 is a block diagram showing a detailed configuration of a detecting device according to a second embodiment of the present invention.

FIG. 14 is a signal waveform diagram for describing a method of driving a location detection electrode group in the second embodiment.

FIG. 15 is a signal waveform diagram for describing a method of driving the location detection electrode group in a variant of the second embodiment.

FIG. 16 is a block diagram showing a detailed configuration of a detecting device according to a third embodiment of the present invention.

FIG. 17 is a diagram for describing electrode group drive schemes in the third embodiment.

FIG. 18 is a diagram for describing electrode group drive schemes in the third embodiment.

FIG. 19 is a flowchart for describing a first example of the flow of switching between electrode group drive schemes in the third embodiment.

FIG. 20 is a flowchart for describing a second example of the flow of switching between electrode group drive schemes in the third embodiment.

FIG. 21 is a diagram for describing electrode group drive schemes prepared in the detecting device in a first specific example in the third embodiment.

FIG. 22 is a flowchart for describing the first specific example of the flow of switching between electrode group drive schemes in the third embodiment.

FIG. 23 is a diagram for describing electrode group drive schemes prepared in the detecting device in a second specific example in the third embodiment.

FIG. 24 is a flowchart for describing the second specific example of the flow of switching between electrode group drive schemes in the third embodiment.

FIG. 25 is a diagram for describing electrode group drive schemes prepared in the detecting device in a third specific example in the third embodiment.

FIG. 26 is a flowchart for describing the third specific example of the flow of switching between electrode group drive schemes in the third embodiment.

FIG. 27 is a diagram for describing location detection in a conventional touch panel.

### MODES FOR CARRYING OUT THE INVENTION

Embodiments of the present invention will be described below with reference to the accompanying drawings.

### 1. First Embodiment

### <1.1 Overall Configuration and Overview of Operation>

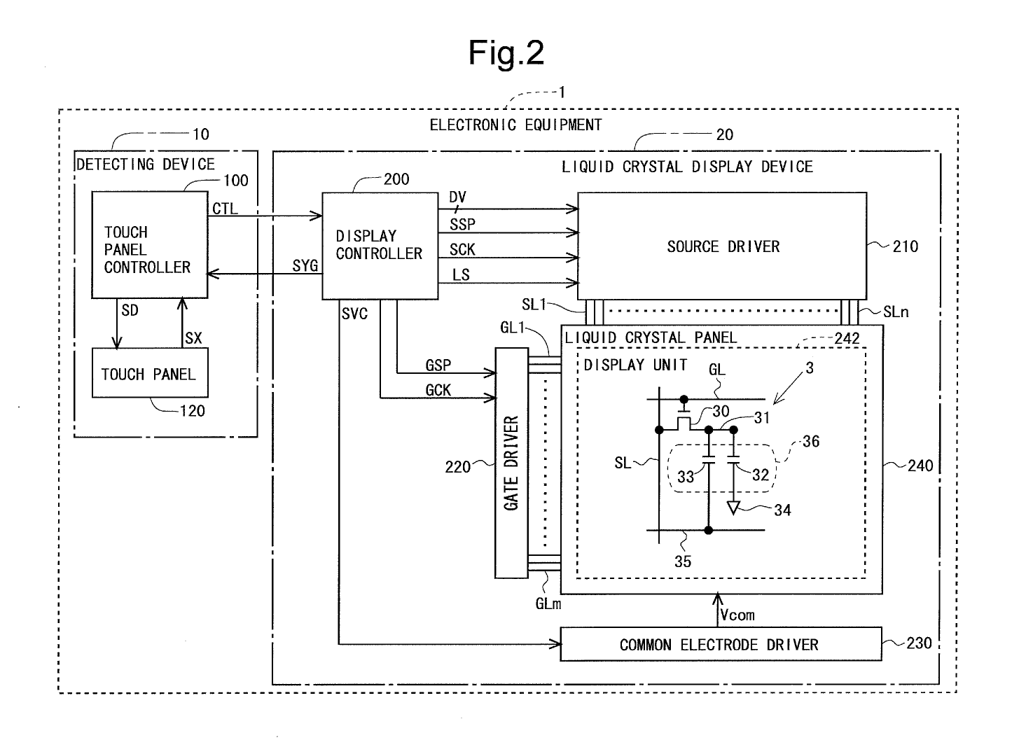

FIG. 2 is a block diagram showing an overall configuration of electronic equipment 1 including a detecting device 10 according to a first embodiment of the present invention. The electronic equipment 1 is composed of the detecting device 10 and a liquid crystal display device 20. Note that the electronic equipment 1 may further include a controller that mediates the exchange of various types of data between the detecting device 10 and the liquid crystal display device 20.

The detecting device 10 is composed of a touch panel controller 100 and a touch panel 120. Note that, in the present embodiment, a detection control unit is implemented by the touch panel controller 100, and a sensing unit is implemented by the touch panel 120. The touch panel controller 100 receives a synchronizing signal group SYG which is transmitted from a display controller 200 in the liquid crystal display device 20, and outputs drive signals SD for performing a location detection process to the touch panel 120. Note that in this specification a series of processes for detecting a location, on the touch panel 120, contacted or approached by an object to be detected (detection object) are referred to as “location detection process”.

The touch panel 120 detects the contact or approach of an object to be detected such as a finger of a user (an operator of the electronic equipment 1) or a touch pen. Detection timing is determined based on the drive signals SD outputted from the touch panel controller 100. When the contact or approach of the object to be detected is detected by the touch panel 120, a result of the detection is transmitted as a sense signal SX to the touch panel controller 100 from the touch panel 120. By this, the location of the object to be detected is identified, and a control signal CTL is transmitted to the display controller 200 from the touch panel controller 100, depending on the location. Note that a detailed configuration of the detecting device 10 will be described later.

The liquid crystal display device 20 includes the display controller 200, a source driver (video signal line drive circuit) 210, a gate driver (scanning signal line drive circuit) 220, a common electrode driver 230, and a liquid crystal panel 240. The liquid crystal panel 240 includes a display unit 242 that displays images. Note that a configuration (monolithic configuration) in which at least one of the source driver 210, the gate driver 220, and the common electrode driver 230 is provided within the liquid crystal panel 240 can also be adopted.

Regarding FIG. 2, the display unit 242 has a plurality of (n) source bus lines (video signal lines) SL1 to SLn and a plurality of (m) gate bus lines (scanning signal lines) GL1 to GLm disposed therein. Pixel formation portions 3 forming pixels are provided at respective intersections of the source bus lines SL1 to SLn and the gate bus lines GL1 to GLm. That is, the display unit 242 includes a plurality of (n×m) pixel formation portions 3. The plurality of pixel formation portions 3 are arranged in a matrix form, forming a pixel matrix of m rows×n columns. Each pixel formation portion 3 includes a TFT 30 which is a switching element connected at its gate terminal to a gate bus line GL passing through a corresponding intersection and connected at its source terminal to a source bus line SL passing through the intersection; a pixel electrode 31 connected to a drain terminal of the TFT 30; a common electrode 34 and an auxiliary capacitance electrode 35 which are provided so as to be shared by the plurality of pixel formation portions 3; a liquid crystal capacitance 32 formed by the pixel electrode 31 and the common electrode 34; and an auxiliary capacitance 33 formed by the pixel electrode 31 and the auxiliary capacitance electrode 35. A pixel capacitance 36 is composed of the liquid crystal capacitance 32 and the auxiliary capacitance 33. Note that in the display unit 242 in FIG. 2, only those components provided for one pixel formation portion 3 are shown.

Meanwhile, as the TFTs 30 in the display unit 242, for example, oxide TFTs (thin-film transistors using an oxide semiconductor for their channel layers) can be adopted. More specifically, a TFT whose channel layer is formed of In—Ga—Zn—O (indium gallium zinc oxide) which is an oxide semiconductor having indium (In), gallium (Ga), zinc (Zn), and oxygen (O) as main components (hereinafter, referred to as “In—Ga—Zn—O-TFT”) can be adopted as the TFT 30. By adopting such In—Ga—Zn—O-TFTs, the effects of achieving high definition and low power consumption can be obtained. In addition, transistors using other oxide semiconductors than In—Ga—Zn—O (indium gallium zinc oxide) for their channel layers can also be adopted. For example, even when a transistor using, for its channel layer, an oxide semiconductor including at least one of indium, gallium, zinc, copper (Cu), silicon (Si), tin (Sn), aluminum (Al), calcium (Ca), germanium (Ge), and lead (Pb) is adopted, the same effects can be obtained. Note that the present invention does not exclude the use of other TFTs than oxide TFTs.

The display controller 200 receives the control signal CTL from the touch panel controller 100. In addition, the display controller 200 outputs digital video signals DV, a source start pulse signal SSP, a source clock signal SCK, and a latch strobe signal LS to the source driver 210, outputs a gate start pulse signal GSP and a gate clock signal GCK to the gate driver 220, outputs a common electrode drive signal SVC to the common electrode driver 230, and outputs a synchronizing signal group SYG to the touch panel controller 100.

The source driver 210 receives the digital video signals

DV, the source start pulse signal SSP, the source clock signal SCK, and the latch strobe signal LS which are transmitted from the display controller 200, and applies a driving video signal to each source bus line SL. At this time, the source driver 210 sequentially holds the digital video signals DV indicating voltages to be applied to the respective source bus lines SL, at timing at which pulses of the source clock signal SCK are generated. Then, the held digital video signals DV are converted into analog voltages at timing at which pulses of the latch strobe signal LS are generated. The converted analog voltages are simultaneously applied, as driving video signals, to all of the source bus lines SL1 to SLn.

The gate driver 220 repeats the application of an active scanning signal to each gate bus line GL with one vertical scanning period being a cycle, based on the gate start pulse signal GSP and the gate clock signal GCK which are transmitted from the display controller 200.

The common electrode driver 230 applies a predetermined voltage Vcom to the common electrode 34, based on the common electrode drive signal SVC which is transmitted from the display controller 200.

In the above-described manner, the driving video signals are applied to the source bus lines SL1 to SLn, the scanning signals are applied to the gate bus lines GL1 to GLm, and the predetermined voltage Vcom is applied to the common electrode 34, by which an image is displayed on the display unit 242.

### <1.2 Configuration and Operation of the Detecting Device>

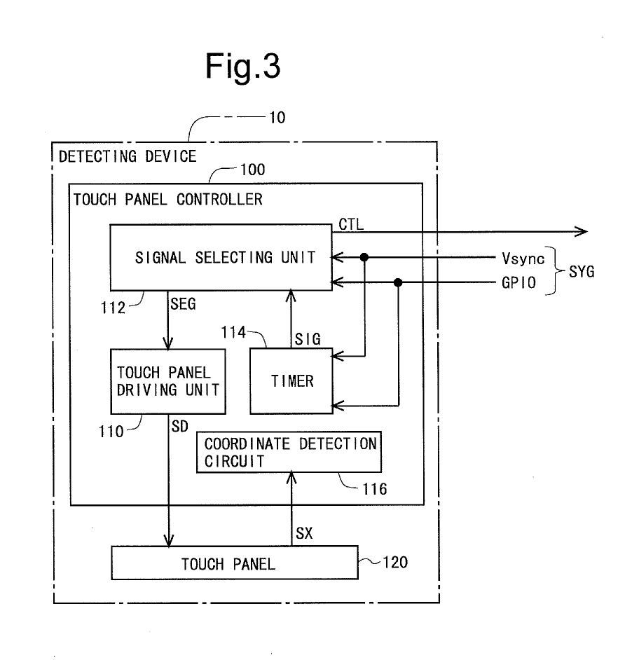

FIG. 3 is a block diagram showing a detailed configuration of the detecting device 10 in the present embodiment. As described above, the detecting device 10 is composed of the touch panel controller 100 and the touch panel 120. As shown in FIG. 3, the touch panel controller 100 is composed of a touch panel driving unit 110, a signal selecting unit 112, a timer 114, and a coordinate detection circuit 116.

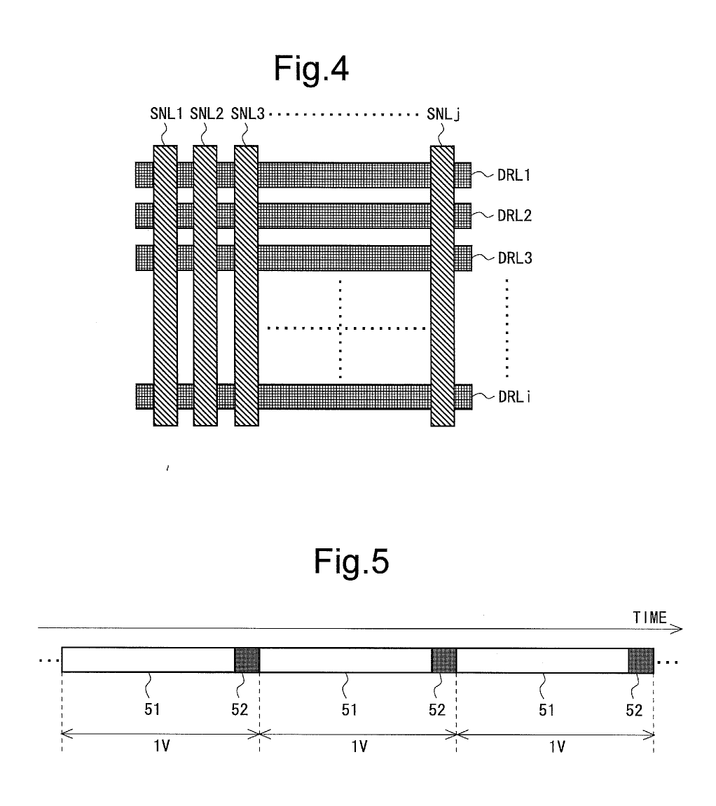

In the touch panel 120, a plurality of electrodes for performing location detection (hereinafter, referred to as “location detection electrode group”) are formed in an area corresponding to the display unit 242 of the liquid crystal display device 20. FIG. 4 is a schematic diagram showing a configuration of the location detection electrode group. In the present embodiment, as the location detection electrode group, i drive lines DRL1 to DRLi and j sensing lines SNL1 to SNLj are disposed in the touch panel 120 so as to intersect each other.

Next, the operation of each component in the touch panel controller 100 (see FIG. 3) will be described. Note that a synchronizing signal group SYG which is transmitted from the display controller 200 in the liquid crystal display device 20 is inputted to the touch panel controller 100. In the present embodiment, the synchronizing signal group SYG includes a vertical synchronizing signal Vsync and a general-purpose input-output signal GPIO. The general-purpose input-output signal GPIO is a signal that is intentionally outputted from the display controller 200.

The timer 114 includes, for example, a clock generator (not shown) that generates internal clocks and a counter (not shown) that counts the internal clocks. The timer 114 generates an internal signal group SIG based on the synchronizing signal group SYG, and outputs the internal signal group SIG to the signal selecting unit 112. The synchronizing signal group SYG and the internal signal group SIG are inputted to the signal selecting unit 112. The signal selecting unit 112 selects one or more signals from among the inputted signals. The signal(s) selected by the signal selecting unit 112 is(are) provided as a selected-signal group SEG to the touch panel driving unit 110.

The touch panel driving unit 110 outputs drive signals SD for driving the location detection electrode group (the drive lines DRL1 to DRLi and the sensing lines SNL1 to SNLj) to the touch panel 120, based on the selected-signal group SEG outputted from the signal selecting unit 112. The touch panel 120 detects the contact or approach of an object to be detected, at timing based on the drive signals SD. The coordinate detection circuit 116 calculates coordinates that identify a location (a location on the touch panel 120) contacted or approached by the object to be detected, based on a sense signal SX serving as a result of the detection. Based on the coordinates calculated by the coordinate detection circuit 116, for example, a menu selected by a user from among a plurality of menus displayed on the display unit 242 is identified.

<1.3 Location detection process>

A location detection process in the present embodiment will be described in detail below.

### <1.3.1 Overview, etc.>

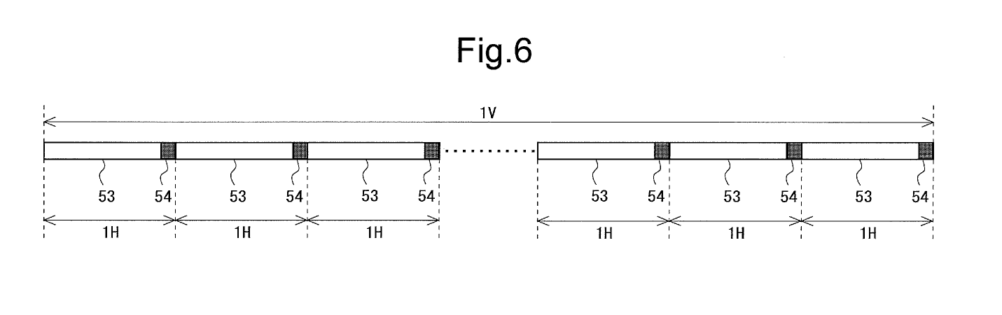

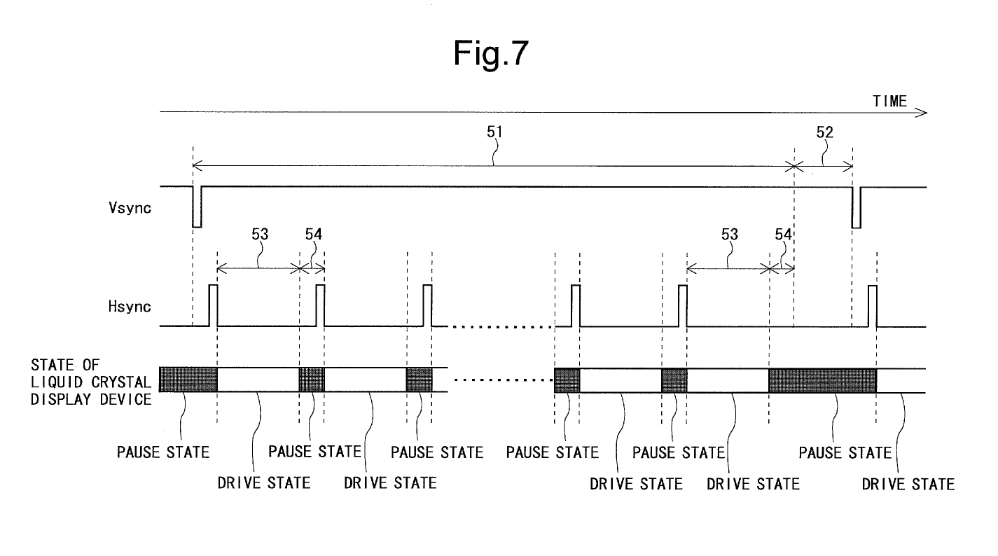

First, basic matters concerning periods will be described. During the operation of the electronic equipment 1, the liquid crystal display device 20 repeats vertical scanning (see FIG. 5). As shown in FIG. 5, a vertical scanning period which is a period during which single vertical scanning is performed includes an effective vertical scanning period 51 and a vertical flyback period 52. Note that in FIG. 5 one vertical scanning period is represented by “1V”. Note also that the liquid crystal display device 20 repeats horizontal scanning during each vertical scanning period (see FIG. 6). As shown in FIG. 6, a horizontal scanning period which is a period during which single horizontal scanning is performed includes an effective horizontal scanning period 53 and a horizontal flyback period 54. Note that in FIG. 6 one horizontal scanning period is represented by “1H”.

As shown in FIG. 7, in the liquid crystal display device 20 in the present embodiment, the fall time of a vertical synchronizing signal Vsync is the start time of a vertical scanning period, and the fall time of a horizontal synchronizing signal Hsync is the start time of a horizontal scanning period. In addition, as shown in FIG. 7, the liquid crystal display device 20 is in a drive state during effective horizontal scanning periods 53 (periods other than horizontal flyback periods 54 within an effective vertical scanning period 51), and the liquid crystal display device 20 is in a pause state during a vertical flyback period 52 and the horizontal flyback periods 54. The vertical flyback period 52 and the horizontal flyback periods 54 are pause periods.

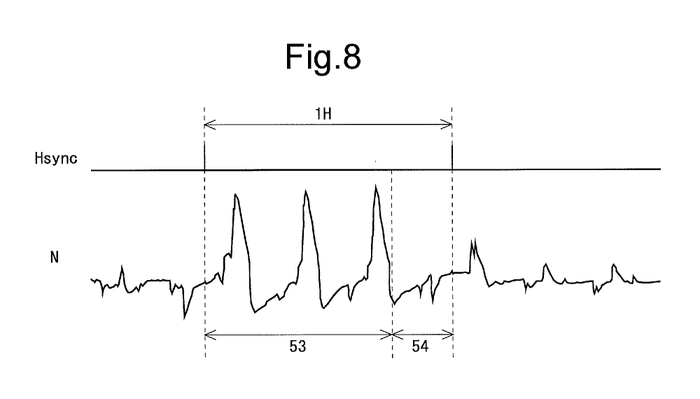

FIG. 8 is a waveform diagram showing a state of noise N generated from a given liquid crystal display device. It can be grasped from FIG. 8 that the level of the noise N during a horizontal flyback period 54 is considerably smaller than that during an effective horizontal scanning period 53. As such, during a period during which driving of the liquid crystal display device is stopped (a period during which a write signal is not outputted to the display unit 242), the level of the noise generated from the liquid crystal display device is small. It is preferred to perform a location detection process for implementing a function susceptible to noise, during such a period with a small noise level, i.e., a pause period.

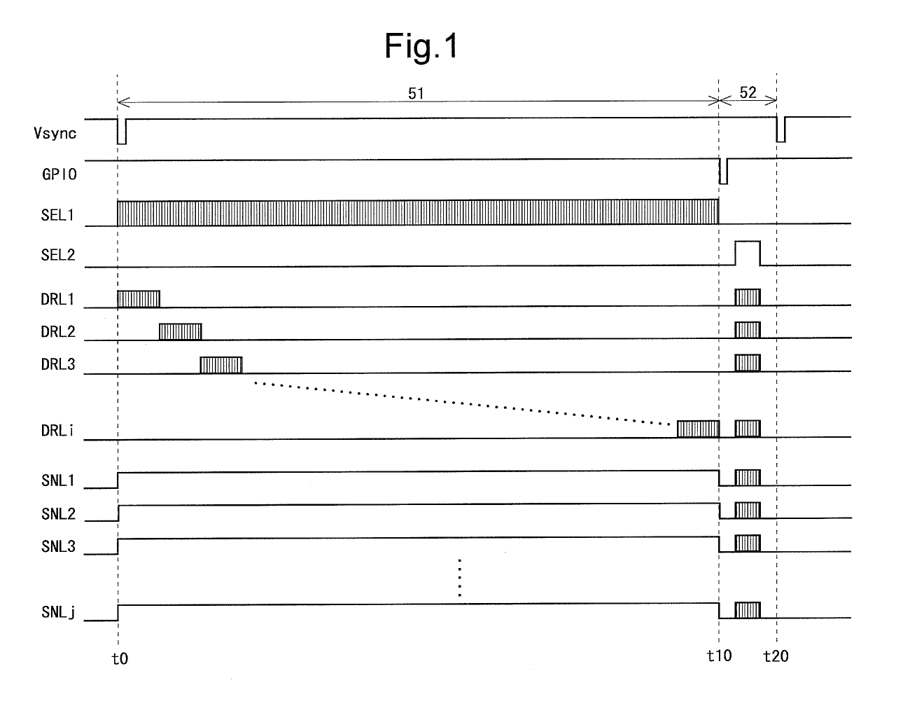

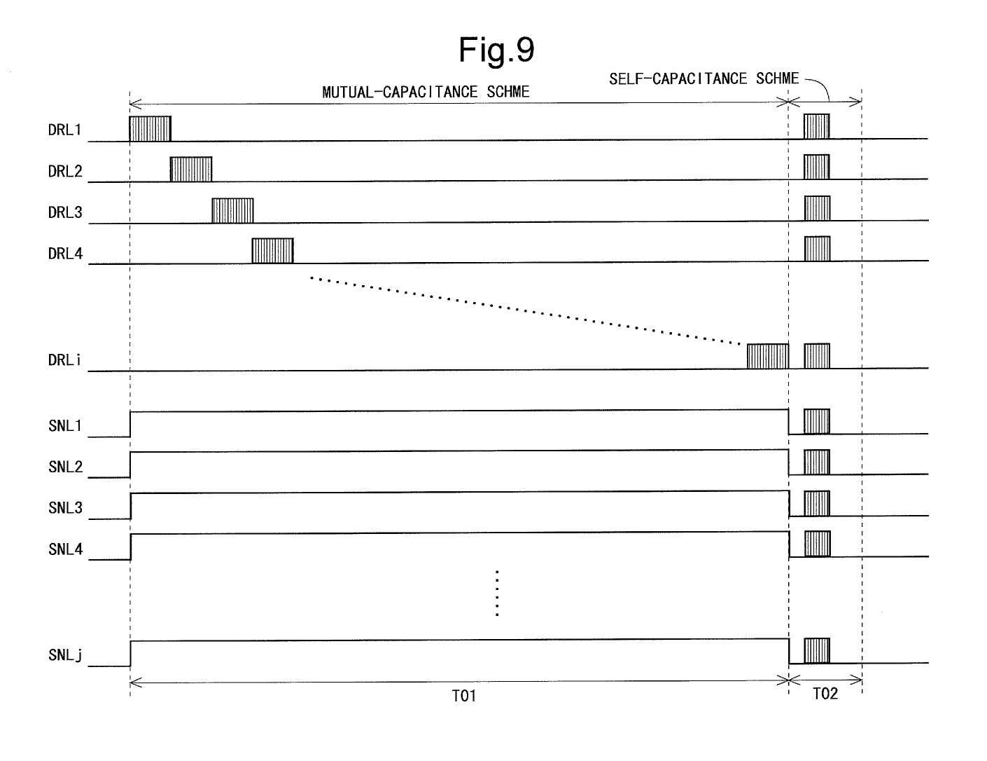

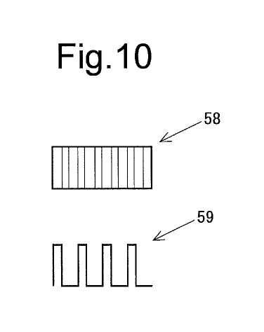

Next, with reference to FIG. 9, a common method of driving the location detection electrode group for when a location detection process is performed will be described. In general, when a location detection process is performed using a mutual-capacitance scheme, the drive lines DRL1 to DRLi are driven one by one, with all of the sensing lines SNL1 to SNLj being in an on state. On the other hand, when a location detection process is performed using a self-capacitance scheme, all of the drive lines DRL1 to DRLi and all of the sensing lines SNL1 to SNLj are simultaneously driven. In the present embodiment, too, the drive lines DRL1 to DRLi and the sensing lines SNL1 to SNLj are thus driven. Note that for FIGS. 1, 9, 12, 14, and 15, a waveform with a vertical stripe pattern (a waveform indicated by reference character 58 in FIG. 10) represents a waveform including a plurality of pulses (the number of pulses is not particularly limited) as indicated by reference character 59 in FIG. 10.

As shown in FIG. 1, in the present embodiment, during an effective vertical scanning period 51, the drive lines DRL1 to DRLi are driven one by one, with all of the sensing lines SNL1 to SNLj being in an on state. In addition, during a vertical flyback period 52, all of the drive lines DRL1 to DRLi and all of the sensing lines SNL1 to SNLj are simultaneously driven. Therefore, in the present embodiment, a location detection process using the mutual-capacitance scheme is performed during the effective vertical scanning period 51, and a location detection process using the self-capacitance scheme is performed during the vertical flyback period 52. Note that the location detection process using the mutual-capacitance scheme is performed during a horizontal flyback period 54 within the effective vertical scanning period 51, as will be described in detail later.

### <1.3.2 Details of the Method of Driving the Location Detection Electrode Group>

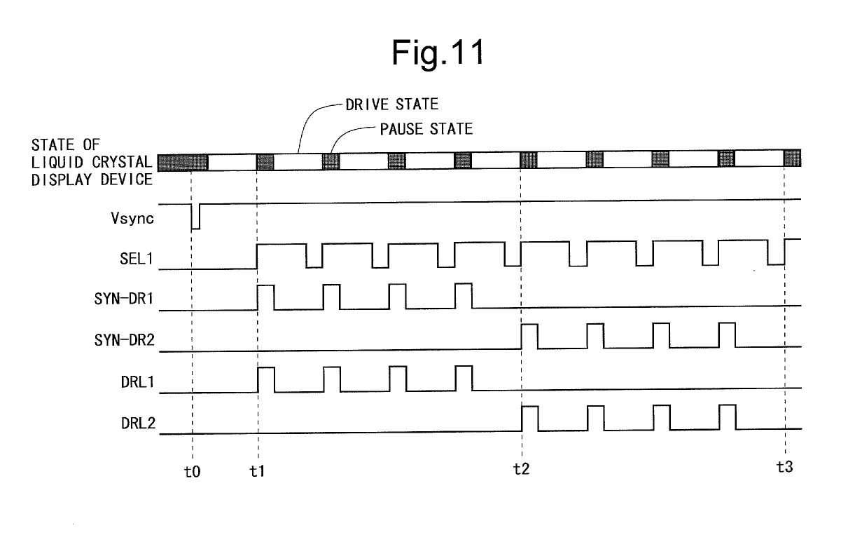

Next, with reference to FIGS. 1 and 11, a method of driving the location detection electrode group in the present embodiment will be described. In the present embodiment, in order to perform a location detection process using the mutual-capacitance scheme during an effective vertical scanning period 51 (specifically, horizontal flyback periods 54 within the effective vertical scanning period 51), a vertical synchronizing signal Vsync is used. In addition, in order to perform a location detection process using the self-capacitance scheme during a vertical flyback period 52, a general-purpose input-output signal GPIO is used.

As shown in FIG. 1, the vertical synchronizing signal Vsync falls at point in time t0. This point in time t0 is the start time of the effective vertical scanning period 51. As shown in FIG. 1, during the effective vertical scanning period 51, the drive lines DRL1 to DRLi are driven one by one. In addition, all of the sensing lines SNL1 to SNLj are maintained in an on state throughout the effective vertical scanning period 51.

Regarding the effective vertical scanning period 51, drive signals for the drive lines DRL1 to DRLi and drive signals for the sensing lines SNL1 to SNLj are generated, for example, as follows. First, the timer 114 (see FIG. 3) counts internal clocks based on the fall of the vertical synchronizing signal Vsync, and thereby generates a mutual-capacitance synchronization selection signal SEL1 (see FIGS. 1 and 11). In addition, the timer 114 counts internal clocks based on the fall of the vertical synchronizing signal Vsync, and thereby generates a first-row driving synchronizing signal SYN-DR1, a second-row driving synchronizing signal SYN-DR2, . . . , an ith-row driving synchronizing signal SYN-DRi (not shown). In an example shown in FIG. 11, a pulse of the mutual-capacitance synchronization selection signal SEL1 and a pulse of the first-row driving synchronizing signal SYN-DR1 rise at point in time t1 which is a point in time where a period corresponding to a predetermined number of internal clocks has elapsed from point in time t0 which is the fall time of the vertical synchronizing signal Vsync. Regarding the mutual-capacitance synchronization selection signal SEL1, pulses are generated at predetermined intervals throughout the effective vertical scanning period 51. Regarding the first-row driving synchronizing signal SYN-DR1, four pulses are generated during a period from point in time t1 to point in time t2. Then, at point in time t2, a pulse of the second-row driving synchronizing signal SYN-DR2 rises. Regarding the second-row driving synchronizing signal SYN-DR2, four pulses are generated during a period from point in time t2 to point in time t3. In this manner, regarding each of the first-row driving synchronizing signal SYN-DR1 to the ith-row driving synchronizing signal SYN-DRi, four pulses are generated during the effective vertical scanning period 51. The mutual-capacitance synchronization selection signal SEL1 and the first-row driving synchronizing signal SYN-DR1 to the ith-row driving synchronizing signal SYN-DRi which are generated by the timer 114 in the above-described manner are provided to the signal selecting unit 112, as signals included in an internal signal group SIG. Then, the signal selecting unit 112 provides the mutual-capacitance synchronization selection signal SEL1 and the first-row driving synchronizing signal SYN-DR1 to the ith-row driving synchronizing signal SYN-DRi to the touch panel driving unit 110, as signals included in a selected-signal group SEG. The touch panel driving unit 110 generates a drive signal for the drive line DRL1, based on the mutual-capacitance synchronization selection signal SEL1 and the first-row driving synchronizing signal SYN-DR1. The drive signal for the drive line DRL1 goes to a high level when both of the mutual-capacitance synchronization selection signal SEL1 and the first-row driving synchronizing signal SYN-DR1 are at a high level. Likewise, the touch panel driving unit 110 generates drive signals for the drive lines DRL2 to DRLi, based on the mutual-capacitance synchronization selection signal SEL1 and each of the second-row driving synchronizing signal SYN-DR2 to the ith-row driving synchronizing signal SYN-DRi. In addition, the touch panel driving unit 110 generates drive signals for the sensing lines SNL1 to SNLj, based on the mutual-capacitance synchronization selection signal SELL The drive signals for the sensing lines SNL1 to SNLj are maintained at a high level throughout the effective vertical scanning period 51.

As shown in FIG. 1, at point in time t10, the general-purpose input-output signal GPIO falls. This point in time t10 is the start time of the vertical flyback period 52. As shown in FIG. 1, during a predetermined period within the vertical flyback period 52, a self-capacitance synchronization selection signal SEL2 is maintained in an on state. During the period during which the self-capacitance synchronization selection signal SEL2 is maintained in an on state, all of the drive lines DRL1 to DRLi and all of the sensing lines SNL1 to SNLj are simultaneously driven.

Regarding the vertical flyback period 52, drive signals for the drive lines DRL1 to DRLi and drive signals for the sensing lines SNL1 to SNLj are generated, for example, as follows. First, the timer 114 counts internal clocks based on the fall of the general-purpose input-output signal GPIO, and thereby generates a self-capacitance synchronization selection signal SEL2. The self-capacitance synchronization selection signal SEL2 is a signal that goes to a high level only during a predetermined period within the vertical flyback period 52. The self-capacitance synchronization selection signal SEL2 generated by the timer 114 is provided to the signal selecting unit 112, as a signal included in an internal signal group SIG. Then, the signal selecting unit 112 provides the self-capacitance synchronization selection signal SEL2 to the touch panel driving unit 110, as a signal included in a selected-signal group SEG. The touch panel driving unit 110 generates drive signals for the drive lines DRL1 to DRLi and drive signals for the sensing lines SNL1 to SNLj, based on the self-capacitance synchronization selection signal SEL2. More specifically, the touch panel driving unit 110 maintains the drive signals for the drive lines DRL1 to DRLi and the drive signals for the sensing lines SNL1 to SNLj at a high level during a period during which the self-capacitance synchronization selection signal SEL2 is at a high level.

In this manner, during the effective vertical scanning period 51, while all of the sensing lines SNL1 to SNLj are maintained in an on state, the drive lines DRL1 to DRLi are sequentially driven using the horizontal flyback periods 54. In addition, during the vertical flyback period 52, all of the drive lines DRL1 to DRLi and all of the sensing lines SNL1 to SNLj are simultaneously driven. By this, a location detection process using the mutual-capacitance scheme is performed during the horizontal flyback periods 54 within the effective vertical scanning period 51, and a location detection process using the self-capacitance scheme is performed during the vertical flyback period 52.

Note that in terms of control for driving the location detection electrode group in the above-described manner, a method of controlling the detecting device 10 includes a self-capacitance scheme detecting step of driving the location detection electrode group such that a location detection process is performed using the self-capacitance scheme; and a mutual-capacitance scheme detecting step of driving the location detection electrode group such that a location detection process is performed using the mutual-capacitance scheme. Here, in the present embodiment, in both of the self-capacitance scheme detecting step and the mutual-capacitance scheme detecting step, the location detection electrode group is driven based on synchronizing signals.

In addition, the configuration of the touch panel controller 100, the configuration of the synchronizing signals SYG used for location detection processes, the method of generating the drive signals (drive signals for the drive lines DRL1 to DRLi and drive signals for the sensing lines SNL1 to SNLj) SD, etc., are not limited to those described above.

### <1.4 Effects>

According to the present embodiment, when a location detection process using the mutual-capacitance scheme is performed, the location detection electrode group is driven based on the vertical synchronizing signal Vsync, and when a location detection process using the self-capacitance scheme is performed, the location detection electrode group is driven based on the general-purpose input-output signal GPIO. By thus driving the location detection electrode group based on the synchronizing signals, a location detection process can be performed during a pause period of the liquid crystal display device 20. In addition, a location detection process using the mutual-capacitance scheme is performed during horizontal flyback periods 54 within an effective vertical scanning period 51, and a location detection process using the self-capacitance scheme is performed during a vertical flyback period 52. That is, a location detection process using a relatively short pause period is performed, and a location detection process using a relatively long pause period is performed. By this, the results of location detection processes performed during two types of pause periods can be used separately depending on a function to be used by the user of the electronic equipment 1. Hence, even when the liquid crystal display device 20 used integrally with the detecting device 10 is a high-resolution display device, by separately using the results of location detection processes performed during two types of pause periods, the performance of the touch panel 120 can be sufficiently exhibited. As described above, according to the present embodiment, the detecting device 10 is implemented that is capable of sufficiently exhibiting its performance even when used integrally with a high-resolution liquid crystal display device (a liquid crystal display device with a relatively short pause period).

### <1.5 Variant>

In the first embodiment, a location detection process using the mutual-capacitance scheme is performed during horizontal flyback periods 54 within an effective vertical scanning period 51, and a location detection process using the self-capacitance scheme is performed during a vertical flyback period 52. However, the present invention is not limited thereto. As in the present variant, the configuration may be such that a location detection process using the self-capacitance scheme is performed during horizontal flyback periods 54 within an effective vertical scanning period 51, and a location detection process using the mutual-capacitance scheme is performed during a vertical flyback period 52.

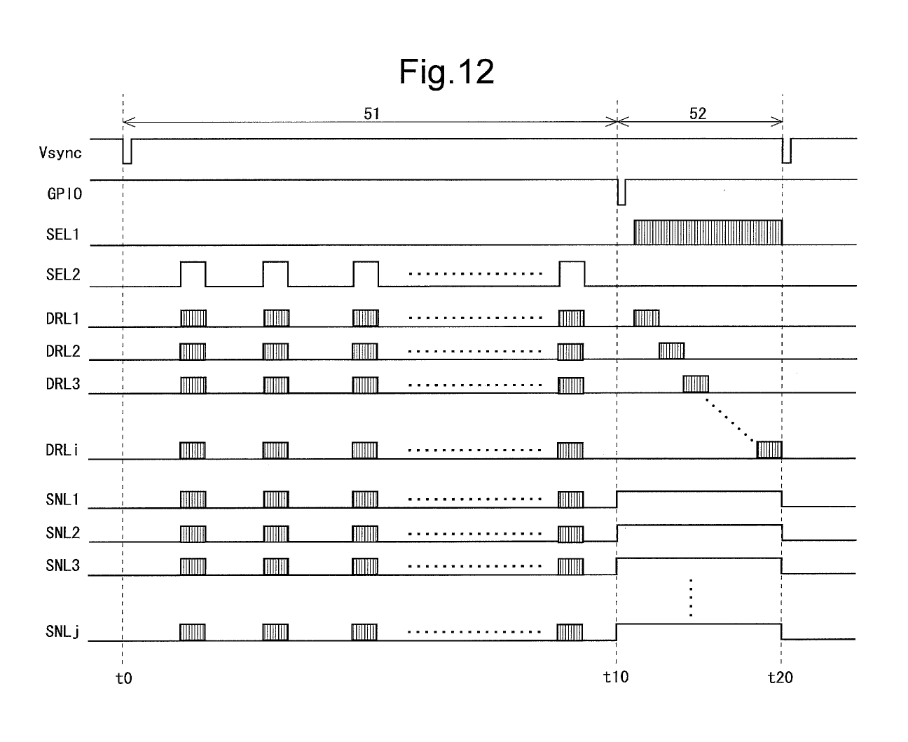

FIG. 12 is a signal waveform diagram for describing a method of driving the location detection electrode group in the present variant. A pulse of a self-capacitance synchronization selection signal SEL2 is generated after a lapse of a predetermined period from point in time t0 where a vertical synchronizing signal Vsync falls. Pulses of the self-capacitance synchronization selection signal SEL2 are generated at predetermined intervals throughout an effective vertical scanning period 51. Note that, in the present variant, the self-capacitance synchronization selection signal SEL2 is generated such that these pulses are generated during horizontal flyback periods 54. Then, during the periods during which the pulses of the self-capacitance synchronization selection signal SEL2 are generated (during the periods during which the self-capacitance synchronization selection signal SEL2 is maintained in an on state), all of the drive lines DRL1 to DRLi and all of the sensing lines SNL1 to SNLj are simultaneously driven.

As shown in FIG. 12, at point in time t10, a general-purpose input-output signal GPIO falls. Based on the general-purpose input-output signal GPIO, all of the sensing lines SNL1 to SNLj are maintained in an on state throughout a vertical flyback period 52. In addition, in the present variant, during the vertical flyback period 52, in the same manner as during the effective vertical scanning period 51 in the first embodiment, a mutual-capacitance synchronization selection signal SEL1 and a first-row driving synchronizing signal SYN-DR1 to an ith-row driving synchronizing signal SYN-DRi are generated, and based on those signals, drive signals for the drive lines DRL1 to DRLi are generated. By this, as shown in FIG. 12, the drive lines DRL1 to DRLi are driven one by one during the vertical flyback period 52.

In the above-described manner, in the present variant, too, location detection processes are performed using two types of pause periods. Therefore, as in the first embodiment, even when the liquid crystal display device 20 used integrally with the detecting device 10 is a high-resolution display device, by separately using the results of location detection processes performed during two types of pause periods, the performance of the touch panel 120 can be sufficiently exhibited.

### 2. Second Embodiment

A second embodiment of the present invention will be described. Note that only differences from the first embodiment will be described.

### <2.1 Configuration>

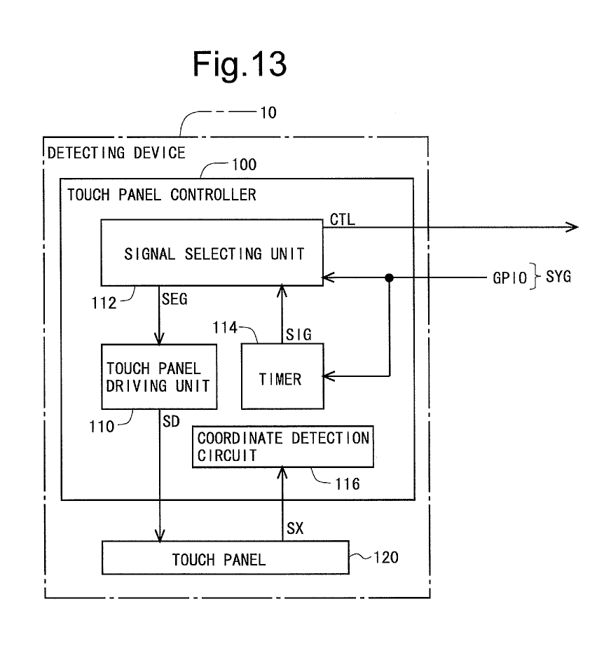

An overall configuration is the same as that of the first embodiment (see FIG. 2). FIG. 13 is a block diagram showing a detailed configuration of a detecting device 10 in the present embodiment. In the first embodiment, a vertical synchronizing signal Vsync and a general-purpose input-output signal GPIO are inputted as synchronizing signals SYG to a touch panel controller 100. On the other hand, in the present embodiment, only a general-purpose input-output signal GPIO is inputted as a synchronizing signal SYG to the touch panel controller 100. Other points are the same as those of the first embodiment.

### <2.2 Location Detection Process>

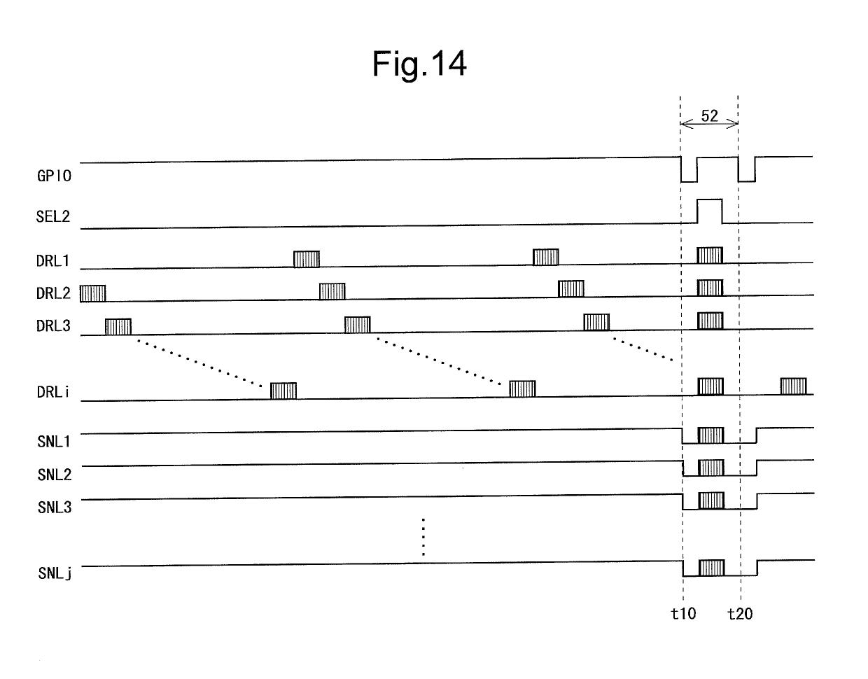

FIG. 14 is a signal waveform diagram for describing a method of driving a location detection electrode group in the present embodiment. In the present embodiment, during a vertical flyback period 52, all drive lines DRL1 to DRLi and all sensing lines SNL1 to SNLj are simultaneously driven. In addition, during a period other than the vertical flyback period 52, the drive lines DRL1 to DRLi are driven one by one, with all of the sensing lines SNL1 to SNLj being in an on state. Therefore, in the present embodiment, a location detection process using the self-capacitance scheme is performed during the vertical flyback period 52, and a location detection process using the mutual-capacitance scheme is performed during a period other than the vertical flyback period 52. A detailed description will be made below.

In the present embodiment, in order to perform a location detection process using the self-capacitance scheme during the vertical flyback period 52, a general-purpose input-output signal GPIO is used. A location detection process using the mutual-capacitance scheme does not use a synchronizing signal. That is, in the present embodiment, a location detection process using the mutual-capacitance scheme is performed asynchronously with the drive operation of a liquid crystal display device 20.

In the present embodiment, in order to perform a location detection process using the mutual-capacitance scheme, the drive lines DRL1 to DRLi are driven one by one in a predetermined cycle without based on a synchronizing signal and with all of the sensing lines SNL1 to SNLj being in an on state. Note, however, that during the vertical flyback period 52, control is performed in the touch panel controller 100 so as to stop such drive operation. By the above, as shown in FIG. 14, during a period other than the vertical flyback period 52, the drive lines DRL1 to DRLi are driven one by one, with all of the sensing lines SNL1 to SNLj being in an on state.

As shown in FIG. 14, at point in time t10, the general-purpose input-output signal GPIO falls. This point in time t10 is the start time of the vertical flyback period 52. As shown in FIG. 14, a self-capacitance synchronization selection signal SEL2 is maintained in an on state during a predetermined period within the vertical flyback period 52. During the period during which the self-capacitance synchronization selection signal SEL2 is maintained in an on state, all of the drive lines DRL1 to DRLi and all of the sensing lines SNL1 to SNLj are simultaneously driven. As described above, during the vertical flyback period 52, the drive lines DRL1 to DRLi and the sensing lines SNL1 to SNLj are driven in the same manner as in the first embodiment (see FIG. 1).

In the above-described manner, in the present embodiment, a location detection process using the self-capacitance scheme is performed synchronously with the drive operation of the liquid crystal display device 20 during the vertical flyback period 52, and a location detection process using the mutual-capacitance scheme is performed not synchronously with the drive operation of the liquid crystal display device 20 during a period other than the vertical flyback period 52.

Note that the configuration may be such that a location detection process using the self-capacitance scheme is performed synchronously with the drive operation of the liquid crystal display device 20 during a horizontal flyback period 54, and a location detection process using the mutual-capacitance scheme is performed not synchronously with the drive operation of the liquid crystal display device 20 during a period other than the horizontal flyback period 54.

### <2.3 Effects>

According to the present embodiment, when a location detection process using the self-capacitance scheme is performed, the location detection electrode group is driven based on the general-purpose input-output signal GPIO. By thus driving the location detection electrode group based on the synchronizing signal, a location detection process using the self-capacitance scheme can be performed during a pause period of the liquid crystal display device 20. In addition, a location detection process using the mutual-capacitance scheme is performed asynchronously with the drive operation of the liquid crystal display device 20 during a period other than the period during which the location detection process using the self-capacitance scheme is performed. That is, a location detection process is performed during a pause period of the liquid crystal display device 20, and a location detection process is also performed during a drive period of the liquid crystal display device 20. Here, by performing a location detection process for implementing a function with a large influence of noise during a pause period of the liquid crystal display device 20, and performing a location detection process for implementing a function with a small influence of noise during a drive period of the liquid crystal display device 20, various types of functions provided to the detecting device 10 are implemented without causing malfunction. In this manner, even when the liquid crystal display device 20 used integrally with the detecting device 10 is a high-resolution display device, by separately using, depending on a function, the result of a location detection process performed during a pause period and the result of a location detection process performed during a drive period, the performance of a touch panel 120 can be sufficiently exhibited. As described above, according to the present embodiment, the detecting device 10 is implemented that is capable of sufficiently exhibiting its performance even when used integrally with a high-resolution liquid crystal display device (a liquid crystal display device with a relatively short pause period).

### <2.4 Variant>

In the first embodiment, a location detection process using the self-capacitance scheme is performed during a vertical flyback period 52 and a location detection process using the mutual-capacitance scheme is performed during a period other than the vertical flyback period 52. However, the present invention is not limited thereto. As in the present variant, the configuration may be such that a location detection process using the mutual-capacitance scheme is performed during a vertical flyback period 52 and a location detection process using the self-capacitance scheme is performed during a period other than the vertical flyback period 52.

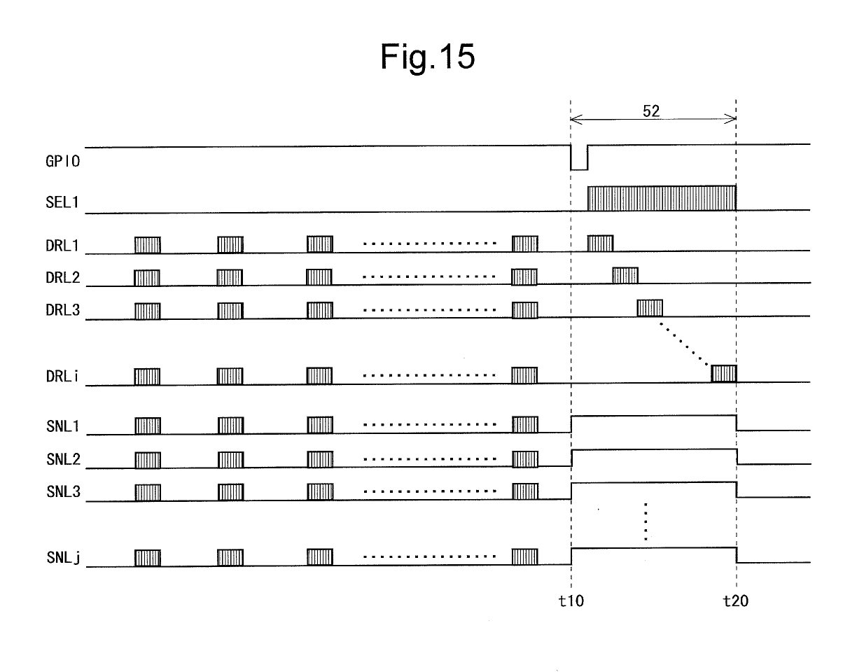

FIG. 15 is a signal waveform diagram for describing a method of driving the location detection electrode group in the present variant. In the present variant, in order to perform a location detection process using the self-capacitance scheme, all of the drive lines DRL1 to DRLi and all of the sensing lines SNL1 to SNLj are simultaneously driven in a predetermined cycle without based on a synchronizing signal. Note, however, that during a vertical flyback period 52, control is performed in the touch panel controller 100 so as to stop such drive operation. By the above, as shown in FIG. 15, during a period other than the vertical flyback period 52, all of the drive lines DRL1 to DRLi and all of the sensing lines SNL1 to SNLj are simultaneously driven.

As shown in FIG. 15, at point in time t10, a general-purpose input-output signal GPIO falls. Based on the general-purpose input-output signal GPIO, all of the sensing lines SNL1 to SNLj are maintained in an on state throughout the vertical flyback period 52. In addition, in the present variant, during the vertical flyback period 52, in the same manner as during an effective vertical scanning period 51 in the first embodiment, a mutual-capacitance synchronization selection signal SEL1 and a first-row driving synchronizing signal SYN-DR1 to an ith-row driving synchronizing signal SYN-DRi are generated, and based on those signals, drive signals for the drive lines DRL1 to DRLi are generated. By this, as shown in FIG. 15, the drive lines DRL1 to DRLi are driven one by one during the vertical flyback period 52.

In the above-described manner, in the present variant, too, a location detection process is performed during a pause period of the liquid crystal display device 20, and a location detection process is also performed during a drive period of the liquid crystal display device 20. Therefore, as in the second embodiment, even when the liquid crystal display device 20 used integrally with the detecting device 10 is a high-resolution display device, by separately using, depending on a function, the result of a location detection process performed during a pause period and the result of a location detection process performed during a drive period, the performance of the touch panel 120 can be sufficiently exhibited.

### <3. Third Embodiment>

A third embodiment of the present invention will be described. Note that only differences from the first embodiment will be described.

### <3.1 Configuration>

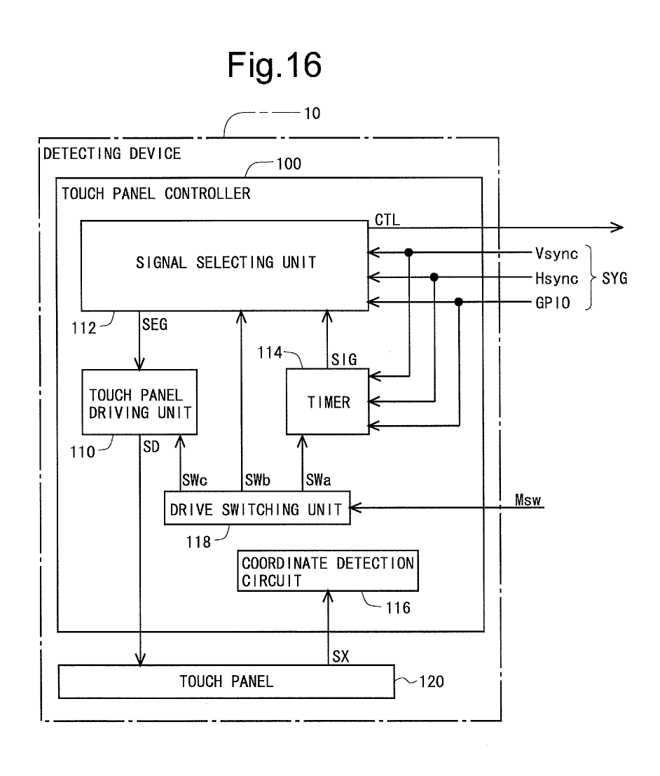

An overall configuration is the same as that of the first embodiment (see FIG. 2). FIG. 16 is a block diagram showing a detailed configuration of a detecting device 10 in the present embodiment. As shown in FIG. 16, a touch panel controller 100 is provided with a drive switching unit 118 in addition to the components in the first embodiment (see FIG. 3). In addition, in the present embodiment, a vertical synchronizing signal Vsync, a horizontal synchronizing signal Hsync, and a general-purpose input-output signal GPIO are inputted as a synchronizing signal group SYG to the touch panel controller 100.

### <3.2 Operation of the Drive Switching Unit>

When the drive switching unit 118 detects a predetermined matter (hereinafter, referred to as “switching factorial matter”) Msw, the drive switching unit 118 provides switching signals SWa, SWb, and SWc to a timer 114, a signal selecting unit 112, and a touch panel driving unit 110, respectively, in order to switch between electrode group drive schemes which will be described later. Examples of the switching factorial matter Msw include selection of a predetermined menu (function) by a user, attachment/detachment of a touch pen to/from electronic equipment 1, and adhesion of a water droplet to a touch panel 120.

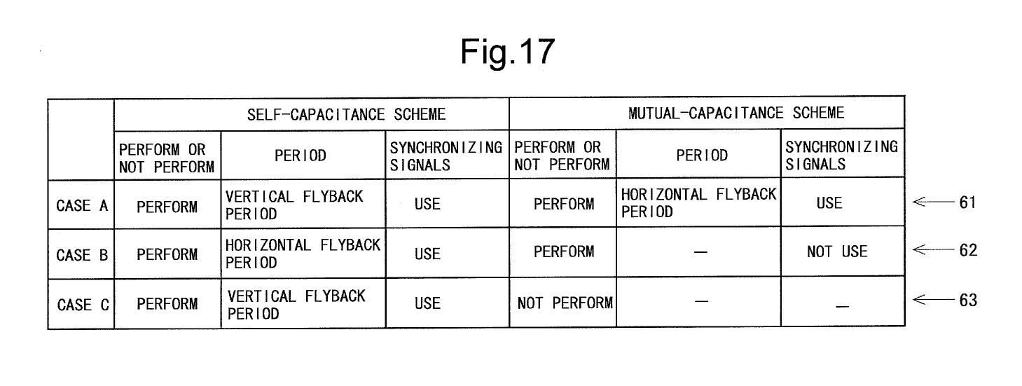

Now, the electrode group drive schemes will be described. In the first embodiment, a location detection process using the self-capacitance scheme is performed during a vertical flyback period 52, and a location detection process using the mutual-capacitance scheme is performed during horizontal flyback periods 54 (see FIG. 1) (this case is referred to as “case A” for convenience). In addition, in the second embodiment, a location detection process using the self-capacitance scheme is performed during a vertical flyback period 52, and a location detection process using the mutual-capacitance scheme is performed not synchronously with the drive operation of a liquid crystal display device 20 during a period other than the vertical flyback period 52 (see FIG. 14) (this case is referred to as “case B” for convenience). Furthermore, there is also considered, for example, a case (referred to as “case C” for convenience) in which a location detection process using the self-capacitance scheme is performed during a vertical flyback period 52 and a location detection process using the mutual-capacitance scheme is not performed. In this specification, to represent how to perform a location detection process in each of the above-described cases, the term “electrode group drive scheme” is used. More specifically, a scheme that is used by the touch panel controller 100 to drive a location detection electrode group and that is identified by a combination of whether to perform a location detection process using the self-capacitance scheme; whether to perform a location detection process using the mutual-capacitance scheme; whether to use synchronizing signals and a period during which the location detection process is performed when a location detection process using the self-capacitance scheme is performed, and whether to use synchronizing signals and a period during which the location detection process is performed when a location detection process using the mutual-capacitance scheme is performed, is referred to as “electrode group drive scheme”. For example, an electrode group drive scheme for the above-described case A is identified as shown in a row indicated by an arrow of reference character 61 in FIG. 17, an electrode group drive scheme for the above-described case B is identified as shown in a row indicated by an arrow of reference character 62 in FIG. 17, and an electrode group drive scheme for the above-described case C is identified as shown in a row indicated by an arrow of reference character 63 in FIG. 17.

In the present embodiment, the detecting device 10 is configured such that the above-described electrode group drive scheme can be switched during the operation of the electronic equipment 1. That is, in the present embodiment, how to perform a location detection process may be switched, for example, from the one described in the first embodiment to the one described in the second embodiment. Specifically, such switching between electrode group drive schemes is performed by the drive switching unit 118 detecting a switching factorial matter Msw as described above. By the drive switching unit 118 outputting switching signals SWa, SWb, and SWc depending on the content of the switching factorial matter Msw, the timer 114, the signal selecting unit 112, and the touch panel driving unit 110 generate various types of signals (an internal signal group SIG, a selected-signal group SEG, and drive signals SD) so as to drive the location detection electrode group by a desired electrode group drive scheme.

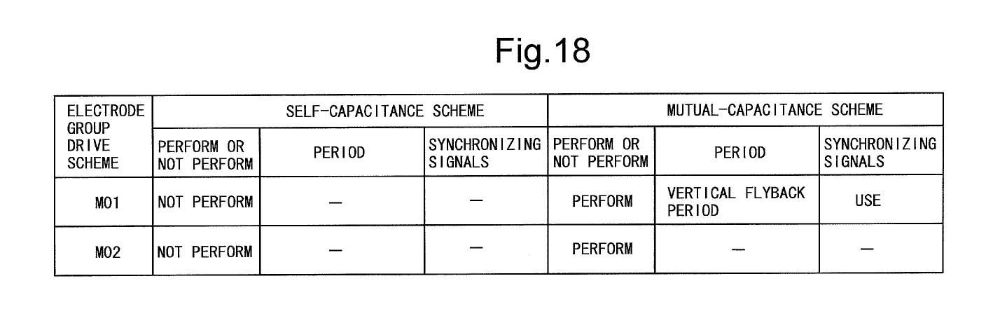

Note that it does not necessarily mean that a location detection process using the self-capacitance scheme or the mutual-capacitance scheme needs to be performed based on synchronizing signals in all electrode group drive schemes prepared in the detecting device 10. For example, when two electrode group drive schemes “scheme M01” and “scheme M02” such as those shown in FIG. 18 are prepared in the detecting device 10, during a period during which the electrode group drive scheme is set to the scheme M02, a location detection process using the self-capacitance scheme is not performed, but a location detection process using the mutual-capacitance scheme is performed without based on synchronizing signals. However, during a period during which the electrode group drive scheme is set to the scheme M01, a location detection process using the mutual-capacitance scheme is performed based on synchronizing signals during a vertical flyback period 52. As such, it is sufficient to drive the location detection electrode group based on synchronizing signals when a location detection process using at least one of the self-capacitance scheme and the mutual-capacitance scheme is performed, in any of a plurality of electrode group drive schemes prepared in the detecting device 10.

### <3.3 Flow of Switching Between Electrode Group Drive Schemes>

### <3.3.1 Overview>

Now, an overview of the flow of switching between electrode group drive schemes will be described using two main examples. Here, it is assumed that two functions “function F2” and “function F3” can be selected by a user, and it is assumed that three electrode group drive schemes “scheme M1”, “scheme M2”, and “scheme M3” are prepared in the detecting device 10. In addition, it is assumed that a suitable electrode group drive scheme for implementing the function F2 is the scheme M2, and a suitable electrode group drive scheme for implementing the function F3 is the scheme M3.

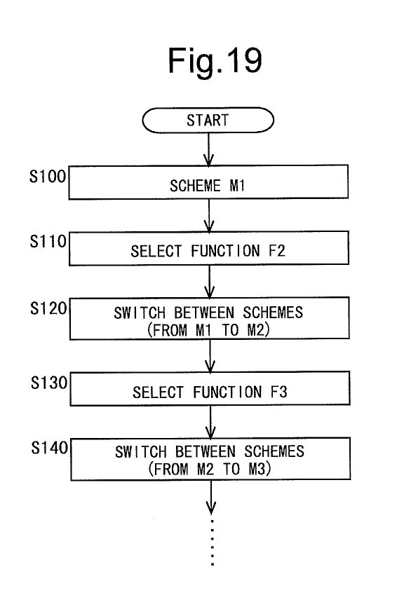

FIG. 19 is a flowchart for describing a first example of the flow of switching between electrode group drive schemes. First, as initial setting, the electrode group drive scheme is set to the scheme M1 (step S100). Thereafter, when the function F2 is selected by the user (step S110), the electrode group drive scheme is switched from the scheme M1 to the scheme M2 (step S120). Thereafter, when the function F3 is selected by the user (step S130), the electrode group drive scheme is switched from the scheme M2 to the scheme M3 (step S140). As such, in the first example, every time a function is selected by the user, switching to a suitable electrode group drive scheme for executing the selected function is performed. Note that there is also considered a case in which suitable electrode group drive schemes for executing two given functions are the same. In such a case, even when a function to be executed is switched between those two functions, switching between electrode group drive schemes is not performed.

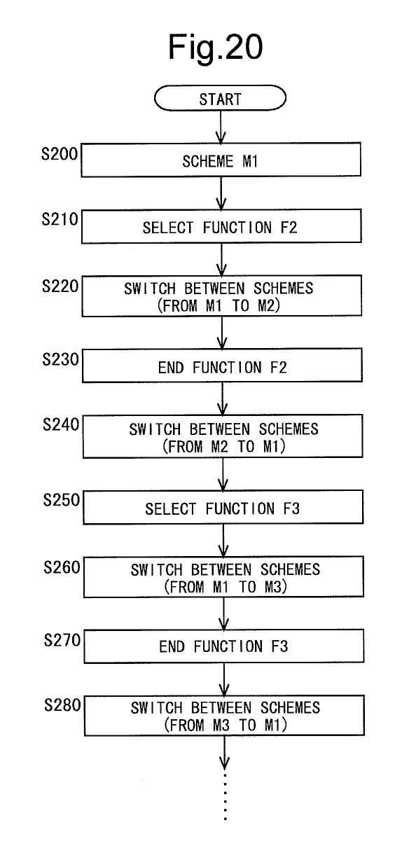

FIG. 20 is a flowchart for describing a second example of the flow of switching between electrode group drive schemes. First, as initial setting, the electrode group drive scheme is set to the scheme M1 (step S200). Thereafter, when the function F2 is selected by the user (step S210), the electrode group drive scheme is switched from the scheme M1 to the scheme M2 (step S220). Thereafter, when execution of the function F2 ends (step S230), the electrode group drive scheme is switched from the scheme M2 to the scheme M1 (step S240). Furthermore, when the function F3 is selected by the user (step S250), the electrode group drive scheme is switched from the scheme M1 to the scheme M3 (step S260). Thereafter, when execution of the function F3 ends (step S270), the electrode group drive scheme is switched from the scheme M3 to the scheme M1 (step S280). As such, in the second example, in normal times, a location detection process is performed based on an electrode group drive scheme of initial setting, and only during a period during which a predetermined function is executed, the electrode group drive scheme is switched to one suitable for executing the function.

In the first example, an electrode group drive scheme switching step is implemented by step S120 and step S140. In the second example, an electrode group drive scheme switching step is implemented by step S220, step S240, step S260, and step S280.

Note that the flow of switching between electrode group drive schemes is not limited to the flows shown in the above-described two examples. Note also that a matter that becomes a factor of switching between electrode group drive schemes (switching factorial matter Msw) is not limited to selection of a function by the user. As described above, switching between electrode group drive schemes is performed upon, for example, attachment/detachment of a touch pen to/from the electronic equipment 1 or adhesion of a water droplet to the touch panel 120 in addition to selection of a function by the user.

### <3.3.2 Specific Examples>

The flow of switching between electrode group drive schemes will be further described using three specific examples.

### <3.3.2.1 First Specific Example>

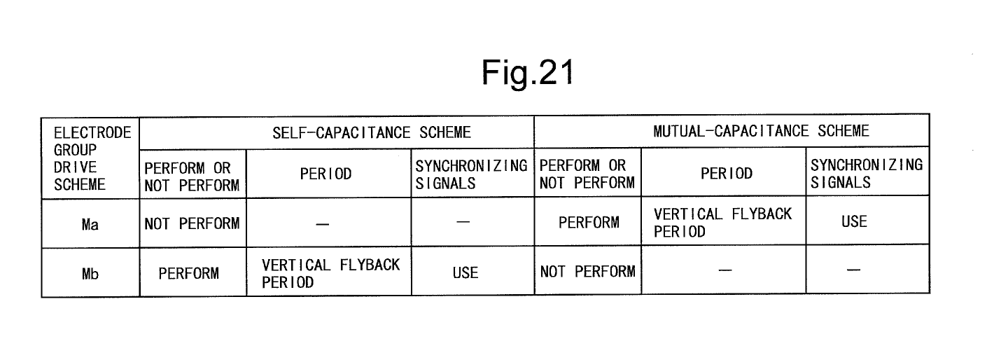

In a first specific example, two electrode group drive schemes “scheme Ma” and “scheme Mb” are prepared in the detecting device 10 (see FIG. 21). During a period during which the electrode group drive scheme is set to the scheme Ma, a location detection process using the self-capacitance scheme is not performed, but a location detection process using the mutual-capacitance scheme is performed using synchronizing signals during a vertical flyback period 52. During a period during which the electrode group drive scheme is set to the scheme Mb, a location detection process using the mutual-capacitance scheme is not performed, but a location detection process using the self-capacitance scheme is performed using synchronizing signals during a vertical flyback period 52. In addition, in the first specific example, switching between electrode group drive schemes is performed at the timing of the start/end of the use of a touch pen provided to the electronic equipment 1 (i.e., the timing of the start/end of a pen input function). A specific flow will be described below.

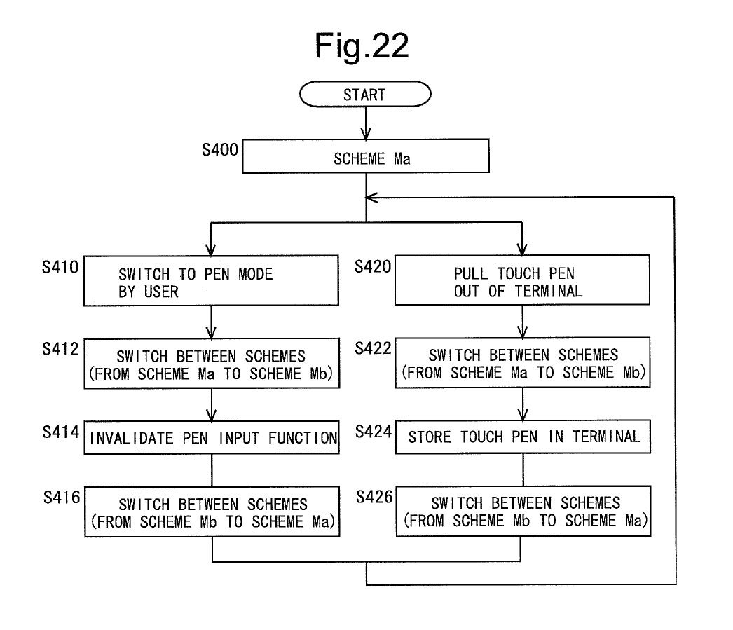

FIG. 22 is a flowchart for describing the first specific example of the flow of switching between electrode group drive schemes. First, as initial setting, the electrode group drive scheme is set to the scheme Ma (step S400). Note that it is assumed that at this point in time the touch pen is being inserted into a predetermined position of the electronic equipment 1. Note also that in the electronic equipment 1 according to the first specific example, as the cases of starting the pen input function, there are a case in which the user intentionally switches to pen mode by executing a predetermined application and a case in which switching to pen mode is performed without a user's intention by pulling the touch pen out of a terminal (electronic equipment 1).

When switching to pen mode is intentionally performed by the user (step S410), the electrode group drive scheme is switched from the scheme Ma to the scheme Mb (step S412). Thereafter, when the pen input function is invalidated by, for example, terminating the application (step S414), the electrode group drive scheme is switched from the scheme Mb to the scheme Ma (step S416). After the completion of step S416, processing returns to a state immediately after step S400.

When the touch pen is pulled out of the terminal (step S420), the electrode group drive scheme is switched from the scheme Ma to the scheme Mb (step S422). Thereafter, when the touch pen is stored in the terminal (step S424), the electrode group drive scheme is switched from the scheme Mb to the scheme Ma (step S426). After the completion of step S426, processing returns to a state immediately after step S400.

As described above, in the detecting device 10 according to the first specific example, during a period during which the pen input function is executed, the location detection electrode group is driven such that a location detection process using the mutual-capacitance scheme is not performed, but a location detection process using the self-capacitance scheme is performed during a vertical flyback period 52. During a period other than the period during which the pen input function is executed, the location detection electrode group is driven such that a location detection process using the self-capacitance scheme is not performed, but a location detection process using the mutual-capacitance scheme is performed during a vertical flyback period 52. In this manner, switching between electrode group drive schemes is performed.

### <3.3.2.2 Second Specific Example>

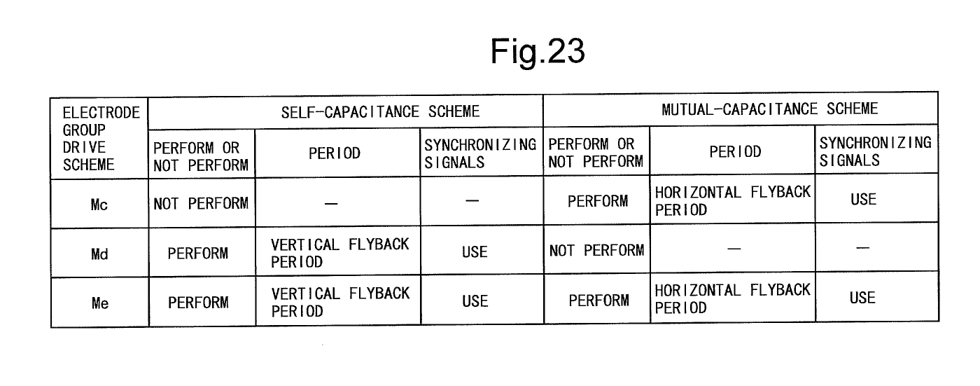

In a second specific example, three electrode group drive schemes “scheme Mc”, “scheme Md”, and “scheme Me” are prepared in the detecting device 10 (see FIG. 23). During a period during which the electrode group drive scheme is set to the scheme Mc, a location detection process using the self-capacitance scheme is not performed, but a location detection process using the mutual-capacitance scheme is performed using synchronizing signals during horizontal flyback periods 54. During a period during which the electrode group drive scheme is set to the scheme Md, a location detection process using the mutual-capacitance scheme is not performed, but a location detection process using the self-capacitance scheme is performed using synchronizing signals during a vertical flyback period 52. During a period during which the electrode group drive scheme is set to the scheme Me, a location detection process using the self-capacitance scheme is performed using synchronizing signals during a vertical flyback period 52, and a location detection process using the mutual-capacitance scheme is performed using synchronizing signals during horizontal flyback periods 54. In addition, in the second specific example, switching between electrode group drive schemes is performed at the timing of the start/end of the execution of a hover function (a function that allows to operate the terminal without directly touching the panel). A specific flow will be described below.

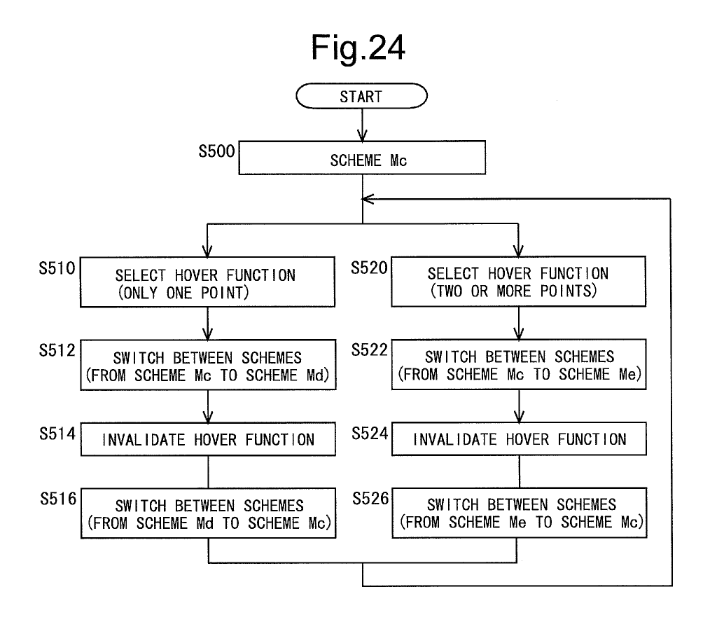

FIG. 24 is a flowchart for describing the second specific example of the flow of switching between electrode group drive schemes. First, as initial setting, the electrode group drive scheme is set to the scheme Mc (step S500). Note that it is assumed that at this point in time the hover function is not being executed. Note also that in the electronic equipment 1 according to the second specific example, as modes used when the hover function is executed, a first mode that allows to instruct only one point and a second mode that allows to instruct two or more points are prepared.

When the user instructs to start the execution of the hover function in the first mode (step S510), the electrode group drive scheme is switched from the scheme Mc to the scheme Md (step S512). Thereafter, when the hover function is invalidated by, for example, terminating an application (step S514), the electrode group drive scheme is switched from the scheme Md to the scheme Mc (step S516). After the completion of step S516, processing returns to a state immediately after step S500.

When the user instructs to start the execution of the hover function in the second mode (step S520), the electrode group drive scheme is switched from the scheme Mc to the scheme Me (step S522). Thereafter, when the hover function is invalidated by, for example, terminating the application (step S524), the electrode group drive scheme is switched from the scheme Me to the scheme Mc (step S526). After the completion of step S526, processing returns to a state immediately after step S500.

As described above, in the detecting device 10 according to the second specific example, during a period during which the hover function in the first mode is executed, the location detection electrode group is driven such that a location detection process using the mutual-capacitance scheme is not performed, but a location detection process using the self-capacitance scheme is performed during a vertical flyback period 52. During a period during which the hover function in the second mode is executed, the location detection electrode group is driven such that a location detection process using the self-capacitance scheme is performed during a vertical flyback period 52, and a location detection process using the mutual-capacitance scheme is performed during horizontal flyback periods 54. During a period during which the hover function is not executed, the location detection electrode group is driven such that a location detection process using the self-capacitance scheme is not performed, but a location detection process using the mutual-capacitance scheme is performed during horizontal flyback periods 54. In this manner, switching between electrode group drive schemes is performed.

### <3.3.2.3 Third Specific Example>

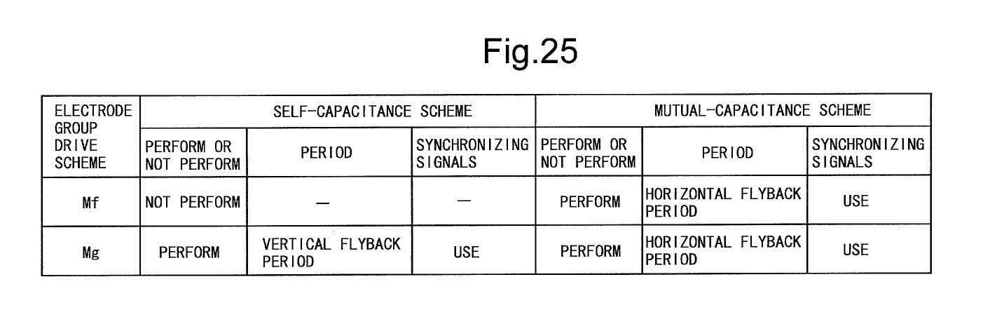

In a third specific example, two electrode group drive schemes “scheme Mf” and “scheme Mg” are prepared in the detecting device 10 (see FIG. 25). During a period during which the electrode group drive scheme is set to the scheme Mf, a location detection process using the self-capacitance scheme is not performed, but a location detection process using the mutual-capacitance scheme is performed using synchronizing signals during horizontal flyback periods 54. During a period during which the electrode group drive scheme is set to the scheme Mg, a location detection process using the self-capacitance scheme is performed using synchronizing signals during a vertical flyback period 52, and a location detection process using the mutual-capacitance scheme is performed using synchronizing signals during horizontal flyback periods 54. In addition, in the third specific example, switching between electrode group drive schemes is performed depending on whether there is adhesion of a water droplet to the touch panel 120. A specific flow will be described below.

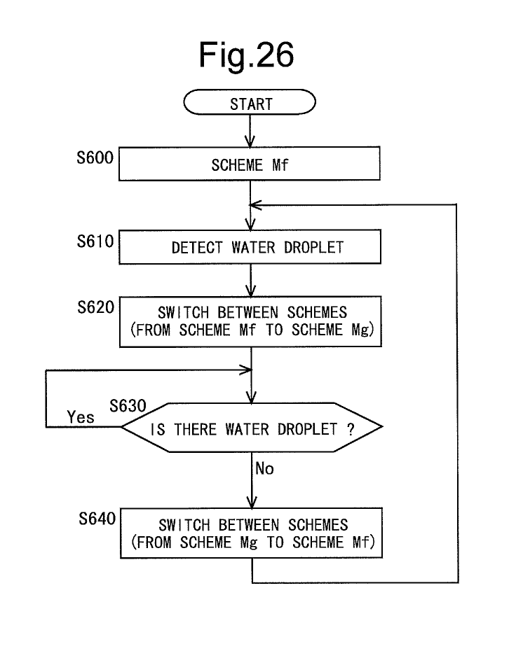

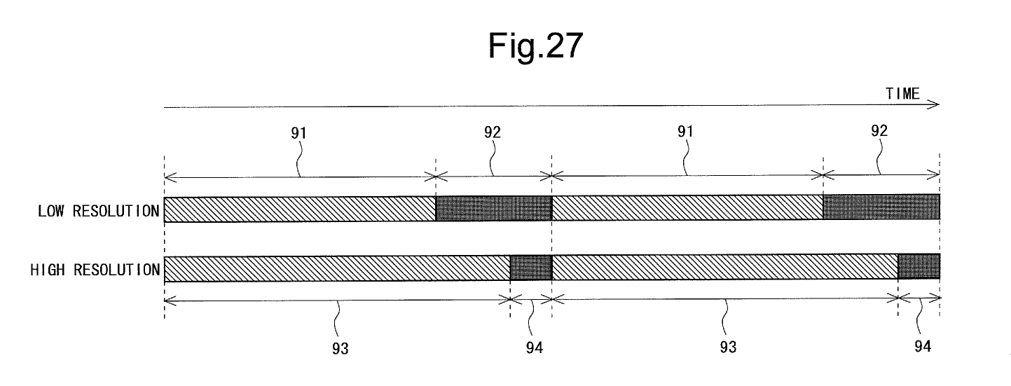

FIG. 26 is a flowchart for describing the third specific example of the flow of switching between electrode group drive schemes. First, as initial setting, the electrode group drive scheme is set to the scheme Mf (step S600). Note that it is assumed that at this point in time there is no water droplet adhered to the touch panel 120. Note also that in the electronic equipment 1 according to the third specific example, a determination as to whether there is adhesion of a water droplet to the touch panel 120 is automatically made by an IC composing the detecting device 10, irrespective of a user's operation.

When adhesion of a water droplet to the touch panel 120 is detected (step S610), the electrode group drive scheme is switched from the scheme Mf to the scheme Mg (step S620). Thereafter, a determination as to whether there is adhesion of a water droplet is made successively (step S630). When adhesion of a water droplet to the touch panel 120 is no longer detected, the electrode group drive scheme is switched from the scheme Mg to the scheme Mf (step S640). After the completion of step S640, processing returns to a state immediately after step S600.

As described above, in the detecting device 10 according to the third specific example, during a period during which the touch panel 120 has a water droplet adhered thereto, the location detection electrode group is driven such that a location detection process using the self-capacitance scheme is performed during a vertical flyback period 52, and a location detection process using the mutual-capacitance scheme is performed during horizontal flyback periods 54. During a period during which the touch panel 120 does not have a water droplet adhered thereto, the location detection electrode group is driven such that a location detection process using the self-capacitance scheme is not performed, but a location detection process using the mutual-capacitance scheme is performed during horizontal flyback periods 54. In this manner, switching between electrode group drive schemes is performed.

### <3.4 Effects>

According to the present embodiment, an electrode group drive scheme (how to perform a location detection process) is switched depending on a predetermined switching factorial matter Msw. In addition, in any of a plurality of electrode group drive schemes prepared in the detecting device 10, a location detection process using at least one of the self-capacitance scheme and the mutual-capacitance scheme is performed based on synchronizing signals. Therefore, by employing a configuration in which the electrode group drive scheme is switched as appropriate depending on the magnitude of the influence of noise exerted on a function to be executed, it is possible to use a pause period of the liquid crystal display device 20 efficiently and to implement various types of functions provided to the detecting device 10 without causing malfunction. By the above, a detecting device is implemented that is capable of sufficiently exhibiting its performance even when used integrally with a high-resolution display device (a display device with a relatively short pause period).

### <4. Others>

The present invention is not limited to the above-described embodiments and variants, and various modifications may be made thereto without departing from the true scope and spirit of the present invention. For example, the present invention can also be applied to a case in which a display device used integrally with the detecting device 10 is other than a liquid crystal display device, such as an organic EL (Electro Luminescence) display device.

### DESCRIPTION OF REFERENCE CHARACTERS

1: ELECTRONIC EQUIPMENT

10: DETECTING DEVICE

20: LIQUID CRYSTAL DISPLAY DEVICE

51: EFFECTIVE VERTICAL SCANNING PERIOD

52: VERTICAL FLYBACK PERIOD

53: EFFECTIVE HORIZONTAL SCANNING PERIOD

54: HORIZONTAL FLYBACK PERIOD

100: TOUCH PANEL CONTROLLER

110: TOUCH PANEL DRIVING UNIT

112: SIGNAL SELECTING UNIT

114: TIMER

116: COORDINATE DETECTION CIRCUIT

118: DRIVE SWITCHING UNIT

120: TOUCH PANEL

200: DISPLAY CONTROLLER

210: SOURCE DRIVER (VIDEO SIGNAL LINE DRIVE CIRCUIT)

220: GATE DRIVER (SCANNING SIGNAL LINE DRIVE CIRCUIT)

230: COMMON ELECTRODE DRIVER

240: LIQUID CRYSTAL PANEL

242: DISPLAY UNIT

DRL1 to DRLi: DRIVE LINE

SNL1 to SNLj: SENSING LINE

Hsync: HORIZONTAL SYNCHRONIZING SIGNAL

Vsync: VERTICAL SYNCHRONIZING SIGNAL

GPIO: GENERAL-PURPOSE INPUT-OUTPUT SIGNAL

SEL1: MUTUAL-CAPACITANCE SYNCHRONIZATION SELECTION SIGNAL

SEL2: SELF-CAPACITANCE SYNCHRONIZATION SELECTION SIGNAL

SYG: SYNCHRONIZING SIGNAL GROUP CLAIMS

1. A detecting device capable of performing a location detection process using both of a self-capacitance scheme and a mutual-capacitance scheme, the location detection process being a process of detecting a location contacted or approached by a detection object, the detecting device comprising,
a sensing unit having a location detection electrode group formed in an area where location detection by the location detection process is to be performed; and
a detection control unit configured to drive the location detection electrode group to perform the location detection process, wherein
the detection control unit drives the location detection electrode group based on a synchronizing signal when the location detection process is performed using at least one of the self-capacitance scheme and the mutual-capacitance scheme.

2. The detecting device according to claim 1, wherein
the location detection electrode group is formed in an area corresponding to an image display unit of an external display device, and
the detecting device is used integrally with the display device.

3. The detecting device according to claim 2, wherein the detection control unit drives the location detection electrode group such that both the location detection process using the self-capacitance scheme and the location detection process using the mutual-capacitance scheme are performed during a pause period that is a period during which operation of the display device is stopped.

4. The detecting device according to claim 3, wherein
when one of the self-capacitance scheme and the mutual-capacitance scheme is defined as a first scheme and an other is defined as a second scheme,
the detection control unit:
drives, during a horizontal flyback period of the display device, the location detection electrode group based on the synchronizing signal such that the location detection process using the first scheme is performed; and
drives, during a vertical flyback period of the display device, the location detection electrode group based on the synchronizing signal such that the location detection process using the second scheme is performed.

5. The detecting device according to claim 2, wherein the detection control unit drives the location detection electrode group such that one of the location detection process using the self-capacitance scheme and the location detection process using the mutual-capacitance scheme is performed during a pause period that is a period during which operation of the display device is stopped.

6. The detecting device according to claim 5, wherein
when one of the self-capacitance scheme and the mutual-capacitance scheme is defined as a first scheme and an other is defined as a second scheme,
the detection control unit:
drives, during a horizontal flyback period of the display device, the location detection electrode group based on the synchronizing signal such that the location detection process using the first scheme is performed; and
drives, during a period other than the horizontal flyback period of the display device, the location detection electrode group such that the location detection process using the second scheme is performed.

7. The detecting device according to claim 5, wherein
when one of the self-capacitance scheme and the mutual-capacitance scheme is defined as a first scheme and an other is defined as a second scheme,
the detection control unit:
drives, during a vertical flyback period of the display device, the location detection electrode group based on the synchronizing signal such that the location detection process using the first scheme is performed; and
drives, during a period other than the vertical flyback period of the display device, the location detection electrode group such that the location detection process using the second scheme is performed.

8. The detecting device according to claim 2, wherein the detection control unit can switch between electrode group drive schemes during operation of the display device, the electrode group drive schemes being used to drive the location detection electrode group and being identified by a combination of whether to perform the location detection process using the self-capacitance scheme; whether to perform the location detection process using the mutual-capacitance scheme; whether to use a synchronizing signal and a period during which the location detection process is performed when the location detection process using the self-capacitance scheme is performed, and whether to use a synchronizing signal and a period during which the location detection process is performed when the location detection process using the mutual-capacitance scheme is performed.

9. The detecting device according to claim 8, wherein the detection control unit switches between the electrode group drive schemes, depending on a function to be executed.

10. The detecting device according to claim 9, wherein
a first drive scheme for an initial state and a second drive scheme for at least one specific function are prepared in advance as the electrode group drive schemes, and
the detection control unit switches the electrode group drive scheme from the first drive scheme to the second drive scheme upon a start of execution of the specific function, and switches the electrode group drive scheme from the second drive scheme to the first drive scheme upon an end of the execution of the specific function.

11. The detecting device according to claim 8, wherein the detection control unit switches between synchronizing signals to be used, depending on the electrode group drive scheme.

12. An electronic equipment comprising a display device having an image display unit; and a detecting device according to claim 1, the detecting device being integrally formed with the display device, wherein
the location detection electrode group is formed in an area corresponding to the image display unit, and
the synchronizing signal is provided to the detection control unit from the display device.

13. A method of controlling a detecting device capable of performing a location detection process using both of a self-capacitance scheme and a mutual-capacitance scheme, the location detection process being a process of detecting a location contacted or approached by a detection object, the method comprising,
a self-capacitance scheme detecting step of driving a location detection electrode group such that the location detection process is performed using the self-capacitance scheme, the location detection electrode group being formed in an area where location detection by the location detection process is to be performed; and
a mutual-capacitance scheme detecting step of driving the location detection electrode group such that the location detection process is performed using the mutual-capacitance scheme, wherein
in at least one of the self-capacitance scheme detecting step and the mutual-capacitance scheme detecting step, the location detection electrode group is driven based on a synchronizing signal.

14. The method of controlling a detecting device according to claim 13, further comprising an electrode group drive scheme switching step of switching between electrode group drive schemes that are used to drive the location detection electrode group and that are identified by a combination of whether to perform the location detection process using the self-capacitance scheme; whether to perform the location detection process using the mutual-capacitance scheme; whether to use a synchronizing signal and a period during which the location detection process is performed when the location detection process using the self-capacitance scheme is performed, and whether to use a synchronizing signal and a period during which the location detection process is performed when the location detection process using the mutual-capacitance scheme is performed.
